(19) United States
(12) Patent Application Publication
(10) Pub. No.: US 2002/0082983 A1
(43) Pub. Date: Jun. 27, 2002

(54) Advertisement opportunity trading system, advertisement opportunity trading method, and recording medium

(75) Inventors: Takashi Oshiba, Tokyo (JP); Kazuaki Nakajima, Tokyo (JP); Masahiro Tabuchi, Tokyo (JP); Tomonari Kamba, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/025,770

(22) Filed: Dec. 26, 2001

(30) Foreign Application Priority Data
Dec. 27, 2000 (JP) 2000-396571

(51) Int. Cl. G06F 17/60

(52) U.S. Cl. 705/37; 705/14

(57) ABSTRACT

An advertisement of a sponsor is distributed on an advertisement opportunity after a trade for the advertisement opportunity is settled. The present invention comprises an advertisement data reception unit which receives advertisement data which a sponsor wants to distribute on an advertisement opportunity, an advertisement opportunity reception unit which receives au advertisement opportunity offered by media, a distribution accepting unit which receives information representing that distribution of the advertisement data is appropriate/inappropriate from the media when the sponsor selects the advertisement opportunity received by the advertisement opportunity reception unit for distributing the advertisement data received by the advertisement data reception unit, and accepts an application for distribution of the advertisement data from the sponsor when the information from the media represents that distribution is appropriate, and a trade process unit which performs a process for trading the advertisement opportunity in accordance with the application accepted by the distribution accepting unit.

### BACKGROUND OF THE INVENTION

1. Field of the Invention

The present invention relates to a business transaction system over a communication network, and particularly relates to an advertisement opportunity trading system, an advertisement opportunity trading method, and a recording medium for trading an advertisement opportunity offered by media.

2. Description of the Related Art

An advertisement opportunity trading system intermediates between a sponsor of an advertisement and media (e.g., a television broadcaster) that distributes an advertisement, when the two parties trade an advertisement opportunity offered by the media over a communication network. For example, “One Media Place” offered by One Media Place Corp. and “cm@uction” offered by Cyber Com Inc. are known as such an advertisement opportunity trading system.

FIG. 24 is a flowchart for explaining the process flow of a conventional advertisement opportunity trading system. An advertisement opportunity has been traded in a conventional advertisement opportunity trading system as follows.

As shown in FIG. 24, media registered as a user of the system (step S2401) registers information about a trading target advertisement opportunity to the market (step S2402). A sponsor registered as a user of the system (step S2403) checks information regarding an advertisement opportunity that is registered to the market (step S2404), and bids for a desired advertisement opportunity (step S2405). The bidden advertisement opportunity undergoes a trading process in the market (step S2406). Once a trade (contract) is settled on a condition offered by a bidding sponsor (step S2407: YES), the sponsor submits data (the content of the advertisement, etc.) of the advertisement to be distributed on the won advertisement opportunity to the media (step S2408). Then, the media examines the content of the submitted advertisement data, and determines whether the distribution of advertisement data is appropriate or not (step S2409). In a case where it is determined that the distribution is appropriate (step S2409; YES), the market distributes the submitted advertisement data and the result of the contract to a distributing facility (step S2410 and step S2411). The distributing facility distributes the advertisement data to an audience's terminal (step S2412), and the advertisement data is displayed on the audience's terminal (step S2413). Through this process, an advertisement designated by a sponsor is distributed to receivers of advertisements, such as television audiences.

As explained above, according to a conventional advertisement opportunity trading system, the media reviews the advertisement data submitted by the sponsor and determines whether the distribution of the advertisement data is appropriate or not, after a contract is settled in the market. Therefore, a time lag is caused between the settlement of a contract and actual distribution of the advertisement.

Further, according to a conventional advertisement opportunity trading system, it is necessary to set the time limit for accepting a bid for an advertisement opportunity in consideration of a period of time between settlement of a contract and actual distribution of an advertisement. However, in order to have an advertisement opportunity won at a higher price, it is preferable to prolong the period of time for accepting a bid for an advertisement opportunity from a sponsor until immediately before a program in which the advertisement is placed is distributed (immediately before the time for distributing the advertisement comes).

### SUMMARY OF THE INVENTION

The present invention was made in view of the above problems, and it is an object of the present invention to provide an advertisement opportunity trading system, an advertisement opportunity trading method, and a recording medium by which an advertisement of a sponsor can be distributed on an advertisement opportunity immediately after the advertisement opportunity was traded.

It is another object of the present invention to provide an advertisement opportunity trading system, an advertisement opportunity trading method, and a recording medium for enabling a trade for an advertisement opportunity by each sponsor to be continued until immediately before the distribution time set for the target advertisement opportunity comes.

To accomplish the above objects, an advertisement opportunity trading system according to a first aspect of the present invention is a system which communicates a terminal of a sponsor of an advertisement and a terminal of media who distributes an advertisement with each other via a communication network, in order to intermediate between the sponsor and the media for facilitating a trade for an advertisement opportunity offered by the media, the system comprising:

advertisement data reception unit which receives advertisement data from a sponsor who wants the advertisement data to be distributed on an advertisement opportunity;

an advertisement opportunity reception unit which receives an advertisement opportunity offered by media;

a distribution accepting unit which receives information representing that distribution of the advertisement data is appropriate/inappropriate from the media when the sponsor selects the advertisement opportunity received by the advertisement opportunity reception unit for distributing the advertisement data received by the advertisement data reception unit, and accepts and application for distribution of the advertisement data from the sponsor when determined that the information from the media represents that distribution is appropriate; and

a trade process unit which performs a process for trading the advertisement opportunity based on the application accepted by the distribution accepting unit.

According to this structure, an application for distribution of advertisement data from a sponsor is accepted in a case where media determines that distribution of the advertisement data is appropriate. Therefore, it becomes unnecessary for the media to determine whether distribution of the advertisement data is appropriate or not after a trade for an advertisement opportunity is settled. And it is possible to distribute the advertisement data of the sponsor on the advertisement opportunity immediately after the trade for the advertisement opportunity is settled. It is also possible for each sponsor to continue trading for an advertisement opportunity until immediately before the distribution time set for the advertisement opportunity comes. Further, it is possible to do a trade for an advertisement opportunity whose sales period from recruitment of sponsors to distribution of advertisement data is short.

In a case where the distribution accepting unit accepts applications for distribution of advertisement data from a plurality of sponsors for a same advertisement opportunity, the trade process unit may put up the advertisement opportunity for auction.

The advertisement opportunity trading system may further comprise:

an advertisement data registration unit which registers the advertisement data received by the advertisement data reception unit;

an advertisement opportunity registration unit which registers the advertisement opportunity received by the advertisement opportunity reception unit; and

an advertisement opportunity publicizing unit which publicizes information on the advertisement opportunity registered in the advertisement opportunity registration unit via the communication network.

The distribution accepting unit may accept an application for distribution of the advertisement data registered in the advertisement data registration unit from the sponsor.

A plurality of advertisement data can be registered by a sponsor in the advertisement data registration unit for one advertisement opportunity.

In a case where the media determines that the plurality of advertisement data of the sponsor are appropriate for distribution on the one advertisement opportunity, the distribution accepting unit may accept an application for distribution of one advertisement data designated by the sponsor from the plurality of advertisement data, as one to be actually distributed.

The advertisement data reception unit may change the advertisement data designated by the sponsor as one to be actually distributed with another advertisement data among the plurality of advertisement data in accordance with an instruction from the sponsor. In this case, the sponsor can change the designated advertisement data with another advertisement data which is determined as appropriate for distribution.

The advertisement data reception unit may receive a genre of the advertisement data.

The advertisement opportunity reception unit may receive a prohibited genre for designating a genre which will not be distributed on the advertisement opportunity.

The advertisement opportunity trading system may further comprise an advertisement data check unit which checks whether the genre of the advertisement data distribution of which on the advertisement opportunity the sponsor applies for corresponds to the prohibited genre or not, and notifies a result of checking to the media. In this case, the media can easily check whether or not the genre of the advertisement data registered by the sponsor corresponds to the prohibited genre designated for the advertisement opportunity. The media's determination whether distribution of advertisement data is appropriate or not is simplified. Thus, even in a case where the media registers numerous advertisement opportunities, the media can easily determine whether distribution of advertisement data is appropriate or not for each of the numerous advertisement opportunities.

The advertisement opportunity trading system may further comprise a competition check unit which checks whether a plurality of sponsors compete in a same business category or not in a case where the distribution accepting unit accepts applications for distribution of advertisement data from the plurality of sponsors for one advertisement opportunity.

The competition check unit may check whether or not competition exists among the plurality of sponsors by a business category of the sponsor.

The trade process unit may permit an application for distribution of advertisement data on the advertisement opportunity from only one sponsor for each business category among the plurality of sponsors, in a case where competition among the plurality of sponsors is detected by checking of the competition check unit.

In this case, it is possible to automatically prevent advertisements or a plurality of sponsors who compete with each other to be distributed on a same advertisement opportunity.

The advertisement opportunity trading system may further comprise an advertisement data mirroring unit which transmits advertisement data which is determined as appropriate for distribution by the media to an advertisement distribution controller which performs distribution of advertisement data.

The advertisement data mirroring unit may transmit the advertisement data to the advertisement distribution controller before a trade for an advertisement opportunity is started by the trade process unit.

The advertisement distribution controller may store the transmitted advertisement data, and perform distribution of the stored advertisement data which is to be distributed on an advertisement opportunity, in a case where a contract for the advertisement opportunity is settled.

To accomplish the above objects, a market control server according to a second aspect of the present invention is a server apparatus for communicating a terminal of a sponsor of an advertisement and a terminal of media who distributes an advertisement with each other via a communication network, in order to intermediate between the sponsor and the media for facilitating a trade for an advertisement opportunity offered by the media, the server comprising:

an advertisement data reception unit which receives advertisement data from a sponsor who wants the advertisement data to be distributed on an advertisement opportunity;

an advertisement opportunity reception unit which receives an advertisement opportunity offered by media;

a distribution accepting unit which receives information representing that distribution of the advertisement data is appropriate/inappropriate from the media when the sponsor selects the advertisement opportunity received by the advertisement opportunity reception unit for distributing the advertisement data received by the advertisement data reception unit, and accepts an application for distribution of the advertisement data from the sponsor when determined that the information from the media represents that distribution is appropriate; and

a trade process unit which performs a process for trading the advertisement opportunity based on the application accepted by the distribution accepting unit.

In a case where the distribution accepting unit accepts applications for distribution of advertisement data from a plurality of sponsors for a same advertisement opportunity, the trade process unit may put up the advertisement opportunity for auction.

The market control server may further comprise:

an advertisement data registration unit which registers the advertisement data received by the advertisement data reception unit;

an advertisement opportunity registration unit which registers the advertisement opportunity received by the advertisement opportunity reception unit; and

an advertisement opportunity publicizing unit which publicizes information on the advertisement opportunity registered in the advertisement opportunity registration unit via the communication network.

In this case, the distribution accepting unit may accept an application for distribution of the advertisement data registered in the advertisement data registration unit from the sponsor.

A plurality of advertisement data can be registered by a sponsor in the advertisement data registration unit for one advertisement opportunity.

In a case where the media determines that the plurality of advertisement data of the sponsor are appropriate for distribution on the one advertisement opportunity, the distribution accepting unit may accept an application for distribution of one advertisement data designated by the sponsor from the plurality of advertisement data, as one to be actually distributed.

The advertisement data reception unit may change the advertisement data designated by the sponsor as one to be actually distributed with another advertisement data among the plurality of advertisement data in accordance with an instruction from the sponsor.

The advertisement data reception unit may receive a genre of the advertisement data.

The advertisement opportunity reception unit may receive a prohibited genre for designating a genre which will not be distributed on the advertisement opportunity.

In this case, the market control server may further comprise an advertisement data check unit which checks whether the genre of the advertisement data distribution of which on the advertisement opportunity the sponsor applies for corresponds to the prohibited genre or not, and notifies a result of checking to the media.

The market control server may further comprise a competition check unit which checks whether a plurality of sponsors compete in a same business category or not in a case where the distribution accepting unit accepts applications for distribution of advertisement data from the plurality of sponsors for one advertisement opportunity.

The competition check unit may check whether or not competition exists among the plurality of sponsors by a business category of the sponsor.

The trade process unit may permit an application for distribution of advertisement data on the advertisement opportunity from only one sponsor for each business category among the plurality of sponsors, in a case where competition among the plurality of sponsors is detected by checking of the competition check unit.

The market control server may further comprise an advertisement data mirroring unit which transmits advertisement data which is determined as appropriate for distribution by the media to an advertisement distribution controller which performs distribution of advertisement data.

The advertisement data mirroring unit may transmit the advertisement data to the advertisement distribution controller before a trade for an advertisement opportunity is started by the trade process unit.

The advertisement distribution controller may store the transmitted advertisement data, and perform distribution of the stored advertisement data which is to be distributed on an advertisement opportunity, in a case where a contract for the advertisement opportunity is settled.

To accomplish the above objects, an advertisement opportunity trading method according to a third aspect of the present invention is a method for communicating a terminal of a sponsor of an advertisement and a terminal of media who distributes an advertisement with each other via a communication network, in order to intermediate between the sponsor and the media for facilitating a trade for an advertisement opportunity offered by the media, the method comprising:

receiving advertisement data from a sponsor who wants the advertisement data to be distributed on an advertisement opportunity;

receiving an advertisement opportunity offered by media;

receiving information representing that distribution of the advertisement data is appropriate/inappropriate from the media when the sponsor selects the advertisement opportunity received in the receiving an advertisement opportunity for distributing the advertisement data received in the receiving advertisement data, and accepting an application for distribution of the advertisement data from the sponsor when determined that the information from the media represents that distribution is appropriate; and

performing a trading process for trading the advertisement opportunity based on the application accepted in the receiving information and accepting an application.

In a case where applications for distribution of advertisement data from a plurality of sponsors are accepted in the receiving information and accepting an application for a same advertisement opportunity, the advertisement opportunity may be put up for auction in the performing a trading process.

The advertisement opportunity trading method may further comprise:

registering the advertisement data received in the receiving advertisement data;

registering the advertisement opportunity received in the receiving an advertisement opportunity; and

publicizing information on the advertisement opportunity registered in the registering the advertisement opportunity via the communication network.

An application for distribution of the advertisement data registered in the registering the advertisement data may be accepted from the sponsor in the receiving information and accepting an application.

A plurality of advertisement data can be registered by a sponsor in the registering the advertisement data for one advertisement opportunity.

In a case where the media determines that the plurality of advertisement data of the sponsor are appropriate for distribution on the one advertisement opportunity, an application for distribution of one advertisement data designated by the sponsor from the plurality of advertisement data may be accepted as one to be actually distributed in the receiving information and accepting an application.

The advertisement data designated by the sponsor as one to be actually distributed may be changed with another advertisement data among the plurality of advertisement data in accordance with an instruction from the sponsor in the receiving advertisement data.

A genre of the advertisement data may be received in the receiving advertisement data.

A prohibited genre for designating a genre which will not be distributed on the advertisement opportunity may be received in the receiving an advertisement opportunity.

The advertisement opportunity trading method may further comprise checking whether the genre of the advertisement data distribution of which on the advertisement opportunity the sponsor applies for corresponds to the prohibited genre or not, and notifying a result of checking to the media.

The advertisement opportunity trading method may further comprise checking whether a plurality or sponsors compete in a same business category or not in a case where applications for distribution of advertisement data from the plurality of sponsors are accepted in the receiving information and accepting an application for one advertisement opportunity.

Whether or not competition exists among the plurality of sponsors may be checked by a business category of the sponsor in the checking.

An application for distribution of advertisement data on the advertisement opportunity from only one sponsor for each business category among the plurality of sponsors may be permitted in the performing a trading process, in a case where competition among the plurality of sponsors is detected in the checking.

The advertising opportunity trading method may further comprise transmitting advertisement data which is determined as appropriate for distribution by the media to an advertisement distribution controller for performing distribution of advertisement data for mirroring purpose.

The advertisement data may be transmitted to the advertisement distribution controller in the transmitting advertisement data before a trade for an advertisement opportunity is started in the performing a trading process.

The advertisement data may be stored in the advertisement distribution controller and may be distributed on an advertisement opportunity by the advertisement distribution controller, in a case where a contract for the advertisement opportunity is settled.

To accomplish the above objects, a computer-readable recording medium according to a fourth aspect of the present invention stores a program for controlling a computer to function as:

advertisement data receiving means for receiving advertisement data from a sponsor who wants the advertisement data to be distributed on an advertisement opportunity;

advertisement data registering means for registering the advertisement data received by the advertisement data receiving means;

advertisement opportunity receiving means for receiving an advertisement opportunity offered by media;

advertisement opportunity registering means for registering the advertisement opportunity received by the advertisement opportunity receiving means;

advertisement opportunity publicizing means for publicizing information on the advertisement opportunity registered by the advertisement opportunity registering means via the communication network;

distribution accepting means for receiving information representing that distribution of the advertisement data is appropriate/inappropriate from the media when the sponsor selects the advertisement opportunity publicized by the advertisement opportunity publicizing means for distributing the advertisement data registered by the advertisement data registering means, and accepting an application for distribution of the advertisement data registered by the advertisement data registering means from the sponsor when determined that the information from the media represents that distribution is appropriate; and

a trade processing means for performing a process for trading the advertisement opportunity based on the application accepted by the distribution accepting means.

The computer-readable recording medium may further store a program for controlling a computer to function as advertisement data checking means for checking whether or not a genre of the advertisement data distribution of which on the advertisement opportunity the sponsor applies for corresponds to a prohibited genre which designates a genre which will not be distributed on the advertisement opportunity, and notifying a result of checking to the media.

The computer-readable recording medium may further store a program for controlling a computer to function as competition checking means for checking whether a plurality of sponsors compete in a same business category or not in a case where applications for distribution of advertisement data from the plurality of sponsors are accepted by the distribution accepting means for one advertisement opportunity, and permitting an application for distribution of advertisement data on the advertisement opportunity from only one sponsor for each business category among the plurality of sponsors in a case where competition exists among the plurality of sponsors.

The computer-readable recording medium may further store a program for controlling a computer to function as:

advertisement data mirroring means for transmitting advertisement data which is determined as appropriate for distribution by the media to advertisement distribution controlling means for performing distribution of advertisement data before a trade for an advertisement opportunity is started by the trade processing means; and

advertisement distribution controlling means for storing the transmitted advertisement data, and performing distribution of the stored advertisement data which is to be distributed on an advertisement opportunity, in a case where a contract for the advertisement opportunity is settled.

To accomplish the above objects, an advertisement distribution control apparatus according to a fifth aspect of the present invention provides information and an advertisement to a terminal of an audience, the apparatus comprising:

distributing means for distributing an advertisement to the terminal of an audience from a market control server which intermediates between a sponsor of an advertisement and various kinds of media which distribute advertisements to facilitate a trade for an advertisement opportunity; and

storing means for receiving advertisement data to be provided to an audience from the market control server, and storing the received advertisement data,

wherein the distributing means starts distributing the advertisement data stored in the storing means to the terminal of an audience from a time set for the advertisement opportunity.

To accomplish the above objects, an advertisement distribution control method according to a sixth aspect of the present invention is a method for providing information and an advertisement to a terminal of an audience, tho method comprising:

distributing an advertisement to the terminal of an audience from a market control server which intermediates between a sponsor of an advertisement and various kinds of media which distribute advertisements to facilitate a trade for an advertisement opportunity; and

receiving advertisement data to be provided to an audience from the market control server, and storing the received advertisement data,

wherein distribution of the advertisement data stored in the receiving and storing advertisement data to the terminal of an audience is started in the distributing from a time set for the advertisement opportunity.

To accomplish the above objects, a computer-readable recording medium according to a seventh aspect of the present invention stores a program for controlling a computer to function as:

distributing means for distributing an advertisement to the terminal of an audience from a market control server which intermediates between a sponsor of an advertisement and various kinds of media which distribute advertisements to facilitate a trade for an advertisement opportunity;

storing means for receiving advertisement data which is made of data regarding an advertisement to be provided to an audience from the market control server, and storing the received advertisement data; and

distribution starting means for starting distribution of the advertisement data stored in the storing means to the terminal of an audience from a time set for the advertisement opportunity.

### BRIEF DESCRIPTION OF THE DRAWINGS

These objects and other objects and advantages of the present invention will become more apparent upon reading of the following detailed description and the accompanying drawings in which:

FIG. 1 is a block diagram showing a structure of an advertisement opportunity trading system according to an embodiment of the present invention;

FIG. 2 is a block diagram showing a specific structure of each component included in the advertisement opportunity trading system according to the embodiment of the present invention;

FIG. 3 is a diagram showing an example of data structure of user information according to the embodiment of the present invention;

FIG. 4 is a diagram showing an example of data structure of advertisement opportunity information according to the embodiment of the present invention;

FIG. 5 is a diagram showing an example of data structure of trading status information according to the embodiment of the present invention;

FIG. 6 is a diagram showing an example of data structure of advertisement data information according to the embodiment of the present invention;

FIG. 7 is a flowchart for explaining a process performed by the advertisement opportunity trading system according to the embodiment of the present invention;

FIG. 8 is a diagram showing the user information according to an example of the embodiment of the present invention;

FIG. 9 is a diagram showing the advertisement opportunity information according to an example of the embodiment of the present invention;

FIG. 10 is a diagram showing the trading status information according to an example of the embodiment of the present invention;

FIG. 11 is a diagram showing the advertisement data information according to a example of the embodiment of the present invention;

FIG. 12 is a diagram showing the user information according to another example of the embodiment of the present invention;

FIG. 13 is a diagram showing the advertisement opportunity information according to another example of the embodiment of the present invention;

FIG. 14 is a diagram showing the trading status information according to another example of the embodiment of the present invention;

FIG. 15 is a diagram showing the advertisement data information according to another information of the embodiment of the present invention;

FIG. 16 is a diagram showing an example of a display screen of a web site run by an advertisement opportunity trading market according to the embodiment of the present invention;

FIG. 18 is a diagram showing an example of a display screen of a web site run by an advertisement opportunity trading market according to the embodiment of the present invention;

FIG. 19 is a diagram showing an example of a display screen of a web site run by an advertisement opportunity trading market according to the embodiment of the present invention;

FIG. 20 is a diagram showing an example of a display screen of a web site run by an advertisement opportunity trading market according to the embodiment of the present invention;

FIG. 21 is a diagram showing an example of a display screen of a web site run by an advertisement opportunity trading market according to the embodiment of the present invention;

FIG. 22 is a diagram showing an example of a display screen of a web site run by an advertisement opportunity trading market according to the embodiment of the present invention;

FIG. 22 is a diagram showing an example of a display screen of a web site run by an advertisement opportunity trading market according to the embodiment of the present invention;

FIG. 23 is a diagram showing an example of a display screen of a web site run by an advertisement opportunity trading market according to the embodiment of the present invention; and

FIG. 24 is a flowchart for explaining a process performed by a conventional advertisement opportunity trading system.

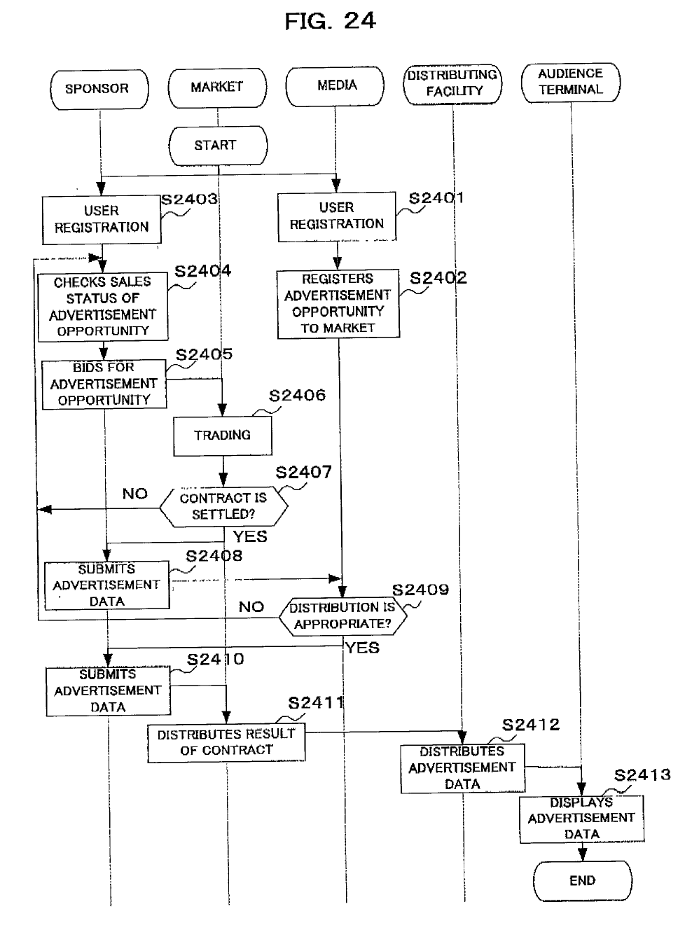

### DETAILED DESCRIPTION OF THE PREFERRED EMBODIMENT

An embodiment of the present invention will now be explained below with reference to the drawings.

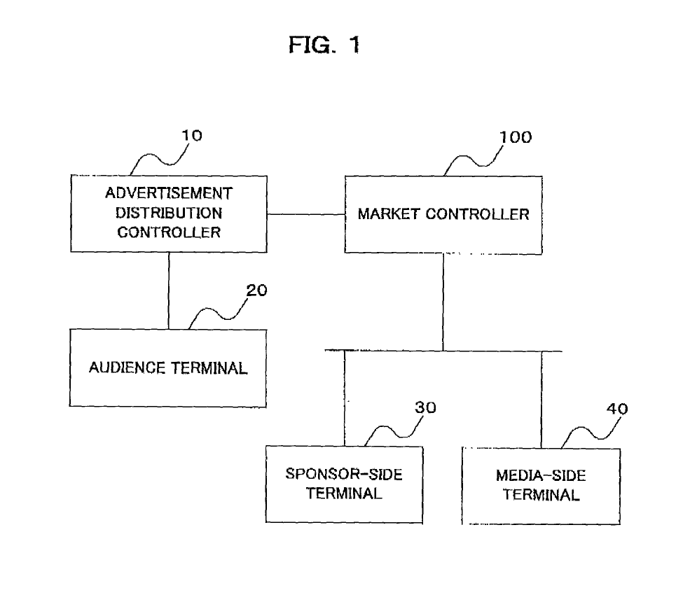

The outline of an advertisement opportunity trading system according to this embodiment of the present invention will now be explained. FIG. 1 is a block diagram illustrating the structure of the advertisement opportunity trading system according to this embodiment.

As shown in FIG. 1, the advertisement opportunity trading system of this embodiment comprises a media-side terminal 40, a sponsor-side terminal 30, a market controller 100, an advertisement distribution controller 10, and an audience terminal 20.

The market controller 100 (a market control server, an advertisement opportunity trading server) is a server for controlling a trade of an advertisement opportunity, and promotes a trade of an advertisement opportunity (or settlement of a contract for an advertisement opportunity) by connecting to the media-side terminal 40, and the sponsor-side terminal 30. For the procedures for trading an advertisement opportunity, a media registers information on an advertisement opportunity to be offered to a sponsor to the market controller 100 by the media-side terminal 40, and a sponsor makes a bid for a desired advertisement opportunity via the market controller 100 by the sponsor-side terminal 30. Then, the market controller 100 settles the trading of the bidden advertisement opportunity on a condition offered by a sponsor.

The market controller 100 is connected to the advertisement distribution controller 10 (such as a broadcasting station) which distributes an advertisement, and notifies information regarding each settled contract for an advertisement opportunity to the advertisement distribution controller 10. The advertisement distribution controller 10, which has received the notification, distributes an advertisement of the settled contract to the audience terminal 20 (a television receiver, a personal computer, etc.).

In this advertisement opportunity trading system, the media previously determines whether advertisement data which represents detailed data of an advertisement which a sponsor wants to distribute is appropriate for public distribution or not. One feature of this advertisement opportunity trading system is that an application for distribution of advertisement data from a sponsor is accepted only in a case where it is determined by the media that the distribution of the advertisement data is appropriate. Due to this feature, it becomes unnecessary for the media to determine whether distribution of advertisement data is appropriate or not after the successful bidder of an advertisement opportunity is determined. Therefore, it is possible to distribute an advertisement at the same time as a contract for an advertisement opportunity is settled. The advertisement opportunity trading system according to this embodiment will now be specifically explained below.

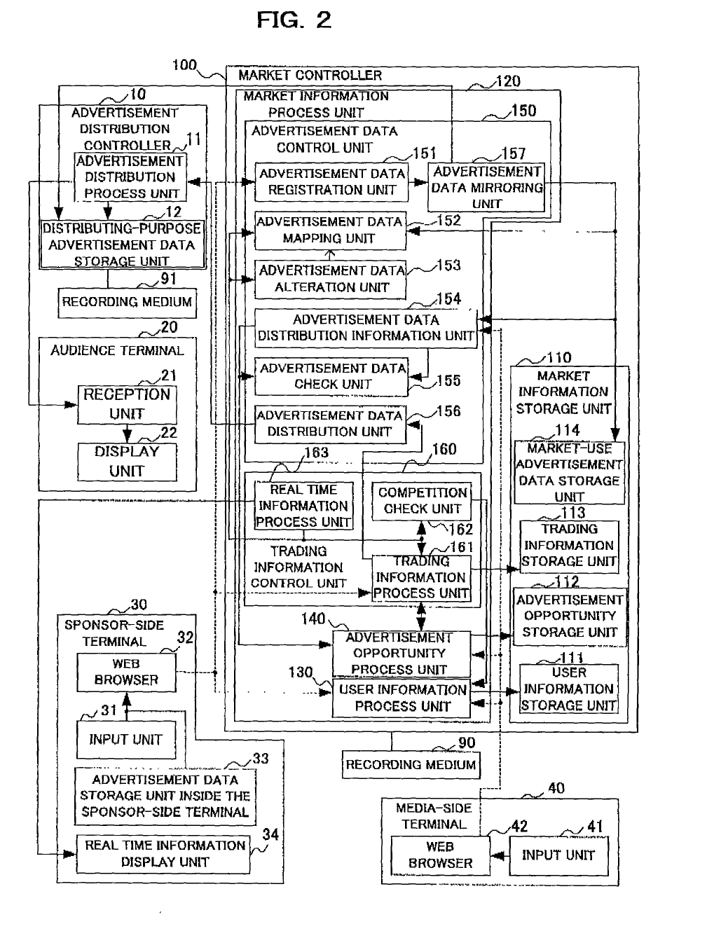

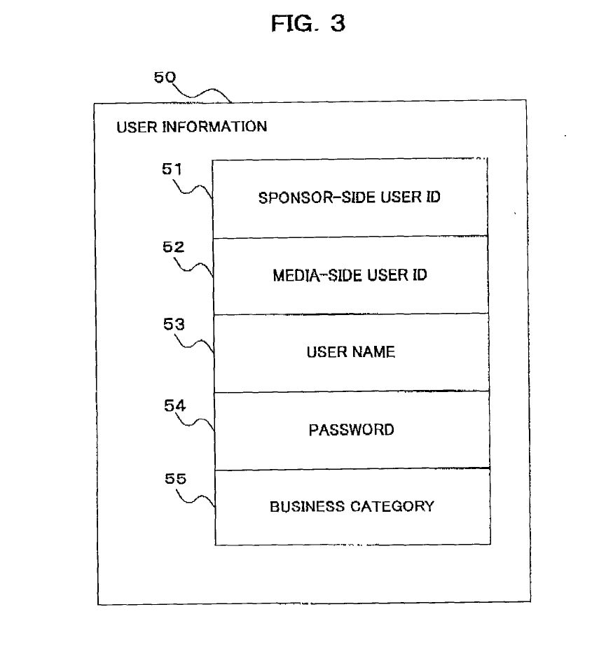

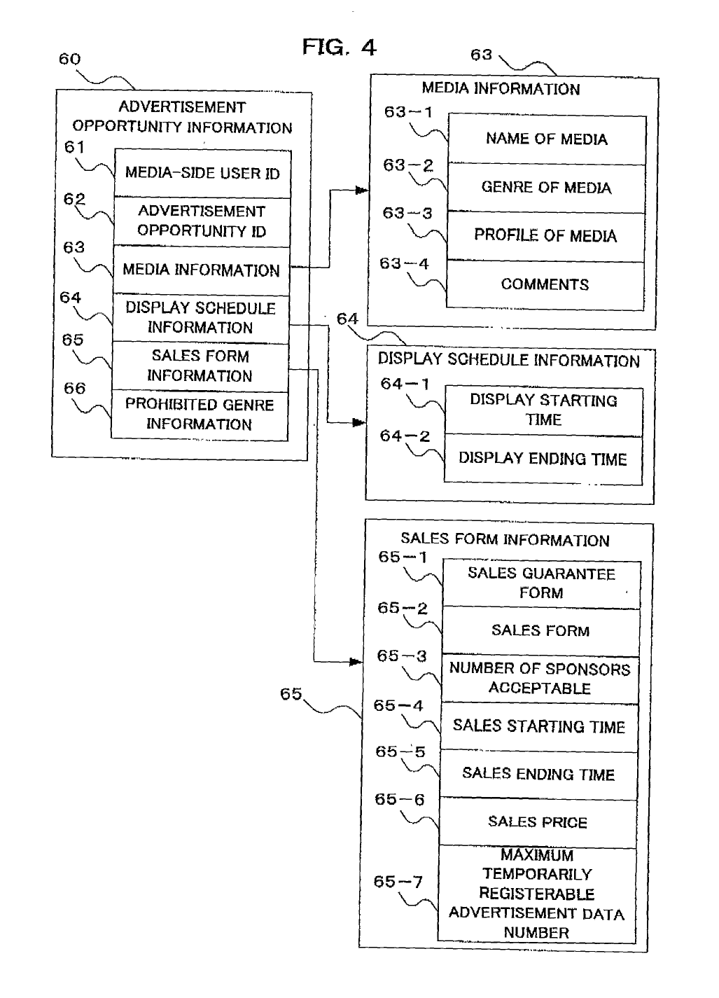

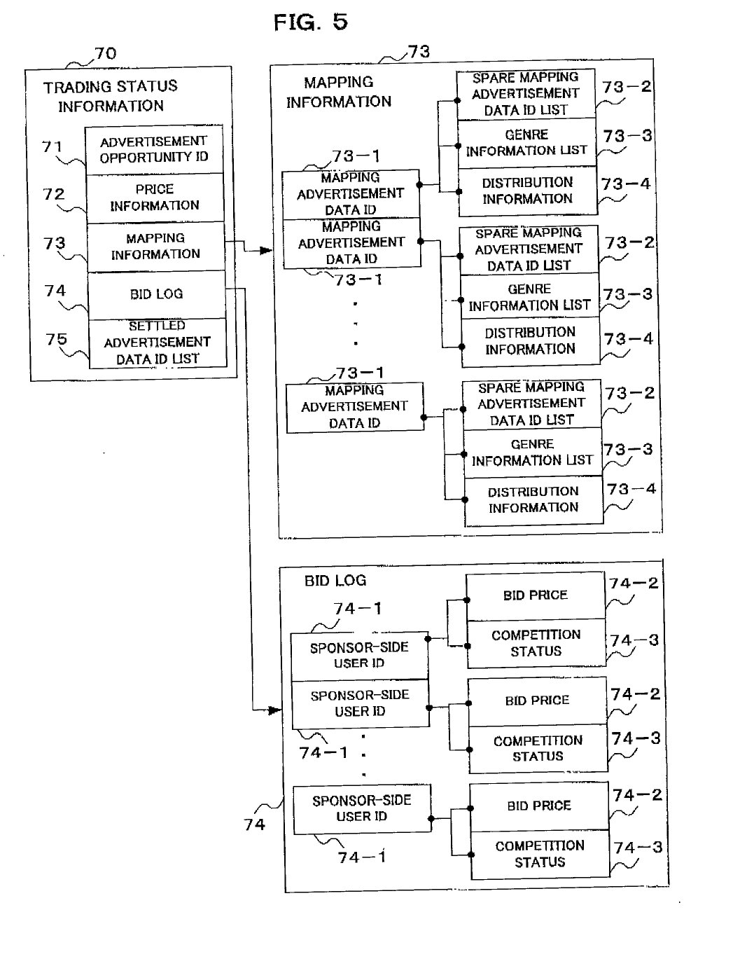

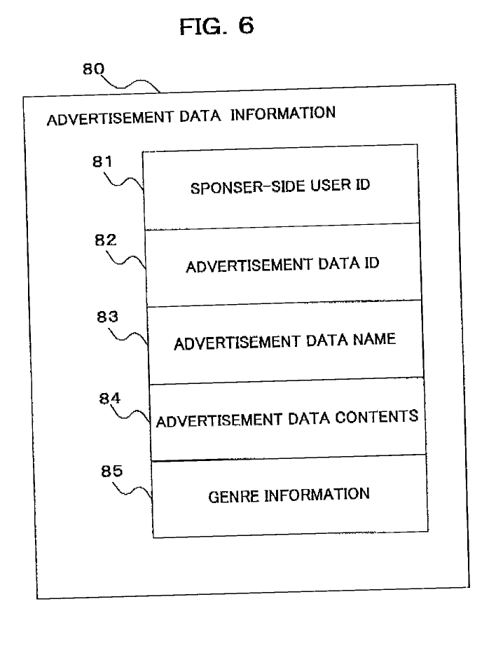

FIG. 2 is a block diagram illustrating a detailed structure of each component of the advertisement opportunity trading system. FIG. 3 to FIG. 6 are diagrams showing examples of data structure according to the advertisement opportunity trading system of this embodiment. FIG. 3 shows an example of data structure of user information 50. FIG. 4 shows an example of data structure of advertisement opportunity information 60. FIG. 5 shows an example of data structure of trading status information 70. FIG. 6 shows an example of data structure of advertisement data information 90.

The sponsor-side terminal 30 comprises an input unit 31, a web browser 32, an advertisement data storage unit 33 which exists inside the sponsor-side terminal 30, and a real time information display unit 34.

The input unit 31 is for a sponsor to input predetermined information. This information is input to the web browser 32. The web browser 32 uploads the information inputted from the input unit 31 in the market controller 100, and displays information downloaded from the market controller 100. The advertisement data storage unit 33 inside the sponsor-side terminal 30 stores a content of advertisement data. The stored advertisement data is to be uploaded in the market controller 100 via the web browser 32. When alteration is made to the trading status information 70, the real time information display unit 34 receives the altered portion from the market controller 100 and displays it. The real time information display unit 34 repeats this process every time alteration is made.

The media-side terminal 40 comprises an input unit 41 and a web browser 42.

The input unit 41 is for the media to input predetermined information. This information is input to the web browser 42. The web browser 42 uploads the information inputted from the input unit 41 in the market controller 100, and displays information downloaded from the market controller 100.

The market controller 100 is a server for controlling an advertisement opportunity trading market run by the advertisement opportunity trading system of this embodiment. The market controller 100 comprises a market information storage unit 110 and a market information process unit 120. The market information process unit 120 comprises a user information process unit 130, an advertisement opportunity process unit 140, an advertisement data control unit 150, and a trading information control unit 160.

The market information storage unit 110 comprises a user information storage unit 111, an advertisement opportunity storage unit 112, a trading information storage unit 113, and a market-use advertisement data storage unit 114.

The user information storage unit 111 accepts access from the user information process unit 130, and stores the user information 50. The advertisement opportunity storage unit 112 accepts access from the advertisement opportunity process unit 140, and stores the advertisement opportunity information 60. The trading information storage unit 113 accepts access from the trading information control unit 160, and stores the trading status information 70. The market-use advertisement data storage unit 114 accepts access from the advertisement data control unit 150, and stores the advertisement data information 80.

The user information process unit 130 accepts access from the web browser 32 of the sponsor-side terminal 30, and the web browser 42 of the media-side terminal 40. Then the user information process unit 130 receives the user information 50 from both the sponsor-side and the media-side, stores the received user information 50 in the user information storage unit 111, and registers the user information 50 in the market.

The advertisement opportunity process unit 140 accepts access from the web browser 42 of the media-side terminal 40, and receives a media-side user ID 52 via the user information process unit 130 as a media-side user ID 61. The advertisement opportunity process unit 140 employs a number which is unique to the market controller 100 as an advertisement opportunity ID 62. Then, the advertisement opportunity process unit 140 stores a set of the employed advertisement opportunity ID 62 and information inputted from the input unit 41 of the media-side terminal 40 in the advertisement opportunity storage unit 112 as the advertisement opportunity information 60, and registers the advertisement opportunity information 60 in the market.

The information inputted from the input unit 41 of the media-side terminal 40 includes media information 63, display schedule information 64, sales form information 65, prohibited genre information 66, and the like. The media information 63 represents the type of media who offers a trading target advertisement opportunity and the position where the advertisement opportunity is to be placed. The display schedule information 64 represents a period of time in which advertisement data is distributed to the audience terminal 20, or a number of times advertisement data is distributed to the audience terminal 20. The sales form information 65 represents selection regarding a sales form for trading an advertisement opportunity between fixed price sales and auction. The prohibited genre information 66 designates a genre of advertisement data that is prohibited from being distributed on the target advertisement opportunity.

After registering the advertisement opportunity information 60 in the market, the advertisement opportunity process unit 140 transmits the employed advertisement opportunity ID 62 to the trading information control unit 160 (a trading information process unit 161) in order to transmit a message that a new advertisement opportunity is registered in the market.

Further, the advertisement opportunity process unit 140 accepts access from the web browser 42 of the media-side terminal 40, the advertisement data control unit 150, the trading information control unit 160, etc., and replies the advertisement opportunity information 60 stored in the advertisement opportunity storage unit 112.

The advertisement data control unit 150 comprises an advertisement data registration unit 151, an advertisement data mapping unit 152, an advertisement data alteration unit 153, an advertisement data distribution information unit 154, an advertisement data check unit 155, an advertisement data distribution unit 156, and an advertisement data mirroring unit 157. The trading information control unit 160 comprises the trading information process unit 161, a competition check unit 162, a real time information process unit 163.

The advertisement data registration unit 151 accepts access from the web browser 32 of the sponsor-side terminal 30, and receives a sponsor-side user ID 51 via the user information process unit, 130 as a sponsor-side user ID 81. The advertisement data registration unit 151 receives advertisement data stored in the advertisement data storage unit 33 inside the sponsor-side terminal 30, and employs a number which is unique to the market controller 100 as an advertisement data ID 82 for the received advertisement data contents 84. Then, the advertisement data registration unit 151 stores the employed advertisement data ID 82 as part of the advertisement data information 80 in the market-use advertisement data storage unit 114 via the advertisement data mirroring unit 157, and registers the advertisement data information 80 in the market.

When registering the advertisement data information 80 in the market, the advertisement data registration unit 151 attaches an advertisement data name 83 and genre information 85 representing a genre of the advertisement data which are inputted from the input unit 31 of the sponsor-side terminal 30 to the advertisement data contents 84, and also registers those as part of the advertisement data information 80. This procedure is indispensable “for the advertisement data distribution unit 156 to distribute a result of a contract settled in the market immediately after the settlement”. The advertisement data registration unit 151 can alter the advertisement data name 83 and the genre information 85, or delete the advertisement data information 80 after registration in accordance with an instruction from the sponsor.

The advertisement data mapping unit 152 accepts access from the web browser 32 of the sponsor-side terminal 30 via the trading information process unit 161. The advertisement data mapping unit 152 receives the sponsor-side user ID 51 via the user information process unit 130, and has the sponsor register their desire as to which advertisement data is distributed on which advertisement opportunity.

The sponsor can temporarily register a plurality of advertisement data which might be publicized. The exact number of advertisement data which can be registered temporarily is indicated by a maximum temporarily registerable advertisement data number 65-7. The temporary registration is done by temporarily registering a list of IDs of advertisement data which might be publicized, in a spare mapping advertisement data ID list 73-2. After temporary registration, the sponsor designates advertisement data which will actually be publicized as a mapping advertisement data ID 73-1.

Specifically, the advertisement data mapping unit 152 obtains the trading status information 70 having an advertisement opportunity ID 71 identical to the advertisement opportunity ID 62 of an advertisement opportunity requested by a sponsor from among the trading status information 70. And the advertisement data mapping unit 152 stores in a data item “mapping information 73” of the obtained trading status information 707 a list of the advertisement data IDs 82 of advertisement data which the sponsor wants to distribute on the advertisement opportunity having the advertisement opportunity ID 62 and a list of the genre information 85 of the same advertisement data respectively as the spare mapping advertisement data ID list 73-2 and a genre information list 73-3. Then, the advertisement data mapping unit 152 registers an ID of advertisement data selected by the sponsor from the spare mapping advertisement data ID list 73-2 as the mapping advertisement data ID 73-1, stores the trading status information 70 in the trading information storage unit 113 via the trading information process unit 161, and registers the trading status information 70 in the market. This process is indispensable for “the advertisement data distribution unit 156 to distribute a result of a contract settled in the market immediately after the settlement”.

The advertisement data mapping unit 152 receives the mapping advertisement data ID 73-1 from the competition check unit 162. Further, the advertisement data mapping unit 152 obtains the advertisement data information 80 from the market-use advertisement data storage unit 114. Then, the advertisement data mapping unit 152 transmits the sponsor-side user ID 81 that corresponds to the mapping advertisement data ID 73-1 to the competition check unit 162.

The advertisement data alteration unit 153 accepts access from the web browser 32 of the sponsor-side terminal 30 via the trading information process unit 161. The advertisement data alteration unit 153 receives the sponsor-side user ID 51 via the user information process unit 130, and alters the advertisement data ID registered as the mapping advertisement data ID 73-1 to another advertisement data ID included in the spare mapping advertisement data ID list 73-2 which is previously registered by the advertisement data mapping unit 152.

The alteration made in the trading status information 70 regarding the reference between the mapping advertisement data ID 73-1 and the spare mapping advertisement data ID list 73-2 is stored in the trading information storage unit 113 via the trading information process unit 161, and registered in the market.

This alteration process is effective only when it is after the mapping of the advertisement opportunity ID 71 and the mapping advertisement data ID 73-1 is completed in the advertisement data mapping unit 152, and before the corresponding mapping advertisement data ID 73-1 is distributed to the trading status information 70 having the corresponding advertisement opportunity ID 71.

The advertisement data distribution information unit 154 accepts access from the web browser 42 of the media-side terminal 40. The advertisement data distribution information unit 154 receives the media-side user ID 52 via the user information process unit 130. Further, the advertisement data distribution information unit 154 selects via the advertisement opportunity process unit 140, the advertisement opportunity information 60 having the media-side user ID 61 identical to the received media-side user ID 52 from among plurality of the advertisement opportunity information 60. Then, the advertisement data distribution information unit 154 obtains a list of advertisement opportunity IDs 62 of the selected advertisement opportunity information 60. The advertisement data distribution information unit 154 also obtains a list of advertisement data IDs 82 that are mapped with each listed advertisement opportunity ID 62, and the corresponding genre information 85 by accessing the trading information process unit 161 via the advertisement opportunity process unit 140. The advertisement data distribution information unit 154 generates a mapping table made of a “list of advertisement opportunity IDs 71”, a “list of mapping advertisement data IDs 73-1” that are mapped with each of the above listed advertisement opportunity IDs 71, and the “genre information list 73-3” which lists the genre information 85 of the advertisement data. The advertisement data distribution information unit 154 transmits the generated mapping table to the web browser 42 of the media-side terminal 40,

The media refers to the received mapping table, and obtains advertisement data contents 84 corresponding to the “list of mapping advertisement data IDs 73-1” from the advertisement data distribution information unit 154. Then, the media checks whether there is any flaw in the contents of the advertisement data and the genre information 85, and determines whether or not the distribution of the advertisement data is appropriate or not by using the input unit 41 of the media-side terminal 40. The result of the determination is sent from the input unit 41 of the media-side terminal 40 to the advertisement data distribution information unit 154. The advertisement data distribution information unit 154 transmits this determination result to the trading information process unit 161 via the advertisement opportunity process unit 140. The trading information process unit 161, stores the determination result as distribution information 73-4. Then, the determination result is stored in the trading information storage unit 113 and registered in the market. This process is indispensable for “the advertisement data distribution unit 156 to distribute a result of a contract settled in the market immediately after the settlement”.

The advertisement data check unit 155 is automatically called when the web browser 42 of the media-side terminal 40 accesses the advertisement data distribution information unit 154. The advertisement data check unit 155 receives the media-side user ID 52 and the mapping table trade of the “list of advertisement opportunity IDs 71”, the “list of mapping advertisement data IDs 73-1” that are mapped with each of the above listed advertisement opportunity IDs 71, and the “genre information list 73-3” which lists the genre information 85 of advertisement data from the advertisement data distribution information unit 154. Further, the advertisement data check unit 155 obtains via the advertisement opportunity process unit 140, the prohibited genre information 66 included in the advertisement opportunity information 60 having advertisement opportunity IDs 62 identical to the listed advertisement opportunity IDs 71.

The advertisement data check unit 155 compares the genre information list 73-3 with the obtained prohibited genre information 66. In a case where there is correspondence between a list item of the genre information list 73-3 and the genre designated by the prohibited genre information 66, the advertisement data check unit 155 rewrites the distribution information 73-4 of the corresponding mapping advertisement data ID 73-1 into a message “butting found against the prohibited genre for the advertisement opportunity”. On the other hand, if there is no correspondence between a list item and the genre designated by the prohibited genre information 66, the advertisement data check unit 155 rewrites the distribution information 73-4 of the corresponding mapping advertisement data ID 73-1 into a message “no butting found against the prohibited genre for the advertisement opportunity”.

When a contract is settled by the trading information process unit 161, the advertisement data distribution unit 156 receives the advertisement opportunity ID 62, a settled advertisement data ID list 75, a display starting time 64-1, a display ending time 64-2, and a number of sponsors acceptable 65-3 from the trading information process unit 161, and distributes those received items to an advertisement distribution process unit 11.

The advertisement data mirroring unit 157 is connected to the advertisement data registration unit 151 inside the advertisement data control unit 150, and is connected to the market-use advertisement data storage unit 114 and a distributing-purpose advertisement data storage unit 12 outside the advertisement data control unit 150.

The advertisement data mirroring unit 157 monitors contents to be stored in the market-use advertisement data storage unit 114, when the contents are written to the market-use advertisement data storage unit 114 by the advertisement data registration unit 151. The advertisement data mirroring unit 157 transmits only a position of the data stored in the market-use advertisement data storage unit 114 altered by the written contents to the advertisement distribution controller 10 (the distributing-purpose advertisement data storage unit 12). Thus, the data held by the advertisement distribution controller 10 always mirrors the data stored in the market-use advertisement data storage unit 114.

The trading information process unit 161 manages the trading status information 70 stored in the trading information storage unit 113. The trading information process unit 161 accepts access from the web browser 32 of the sponsor-side terminal 30, and manages a bid for each registered advertisement opportunity. Further, the trading information process unit 161 obtains the advertisement opportunity information 60 via the advertisement opportunity process unit 140, and manages the sales of an advertisement opportunity in accordance with the sales form information 65. When the trading information process unit 161 writes data in the trading status information 70, the trading information process unit 161 stores the data in the trading information storage unit 113 and at the same time, transmits the portion altered by the written data to the real time information process unit 163.

The trading information process unit 161 manages a contract based on the advertisement opportunity information 60 and the trading status information 70. At the time of closing a contract, if “competition existing” is notified as competition status by the competition check unit 162, the trading information process unit 161 selects only one sponsor from sponsors in the competition, even if an amount adequate for settling a contract is offered as a bid price 74-2 by each sponsor in the competition. And the trading information process unit 161 gives authority to purchase the advertisement opportunity or authority to successfully bid the advertisement opportunity to the selected sponsor. When a contract is settled; the trading information process unit 161 copies the mapping advertisement data ID 73-1 of the advertisement data that is determined to be publicized to the settled advertisement data ID list 75. Then, the trading information process unit 161 transmits the advertisement opportunity ID 62, the settled advertisement data ID list 75, the display starting time 64-1, the display ending time 64-2, and the number of sponsors acceptable 65-3 to the advertisement data distribution unit 156.

The competition check unit 162 obtains sponsor-side user IDs 74-1 from the trading status information 70 obtained via the trading information process unit 161, and accesses the user information process unit 130 in order to obtain corresponding business categories 55. In a case where sponsors belonging to a same business category 55 are found, the competition check unit 162 writes a message “competition existing” in a section “competition status” 74-3 of each competing sponsor. In a case where no sponsors belonging to a same business category 55 are found, the competition check unit 162 writes a message “no competition”.

The real time information process unit 163 receives an altered portion of the trading status information 70 from the trading information process unit 161 every time the alteration is made to the trading status information 70, and transmits the altered portion to the real time information display unit 34.

The advertisement distribution controller 10 (an advertisement distribution control apparatus) comprises the advertisement distribution process unit 11 and the distributing-purpose advertisement data storage unit 12.

The advertisement distribution process unit 11 receives the advertisement opportunity ID 62, the settled advertisement data ID list 75, the display starting time 64-1, the display ending time 64-2, and the number of sponsors acceptable 65-3 from the advertisement data distribution unit 156 when a contact is settled by the trading information process unit 161. Then, the advertisement distribution process unit 11 distributes the number (designated by the number of sponsors acceptable 65-3 obtained from the distributing-purpose advertisement data storage unit 12) of advertisement data listed on the settled advertisement data ID list 75 to a reception unit 21 of the audience terminal 20 during the period of time determined by the display starting time 64-1 and the display ending time 64-2.

The distributing-purpose advertisement data storage unit 12 receives an altered portion of the advertisement data information 80 from the advertisement data mirroring unit 157 in order to make the data stored in the storage unit 12 mirror the data stored in the market-use advertisement data storage unit 114. Due to this mirroring, when the advertisement distribution process unit 11 distributes the advertisement data to the reception unit 21, there is no need to transfer the advertisement data contents 34 from the market-use advertisement data storage unit 114 to the advertisement distribution process unit 11. Thus, large time delay is not caused in the distribution process, and advertisement data can be distributed immediately after a contract is settled in the market.

The audience terminal 20 comprises the reception unit 21 and a display unit 22.

The reception unit 21 receives the number (designated by the number of sponsors acceptable 65-3) of advertisement data listed on the settled advertisement data ID list 75 from the advertisement distribution process unit 11, and transmits the received advertisement data to the display unit 22. The display unit 22 displays the number (designated by the number of sponsors acceptable 65-3) of advertisement data listed on the settled advertisement data ID list 75 obtained from the reception unit 21.

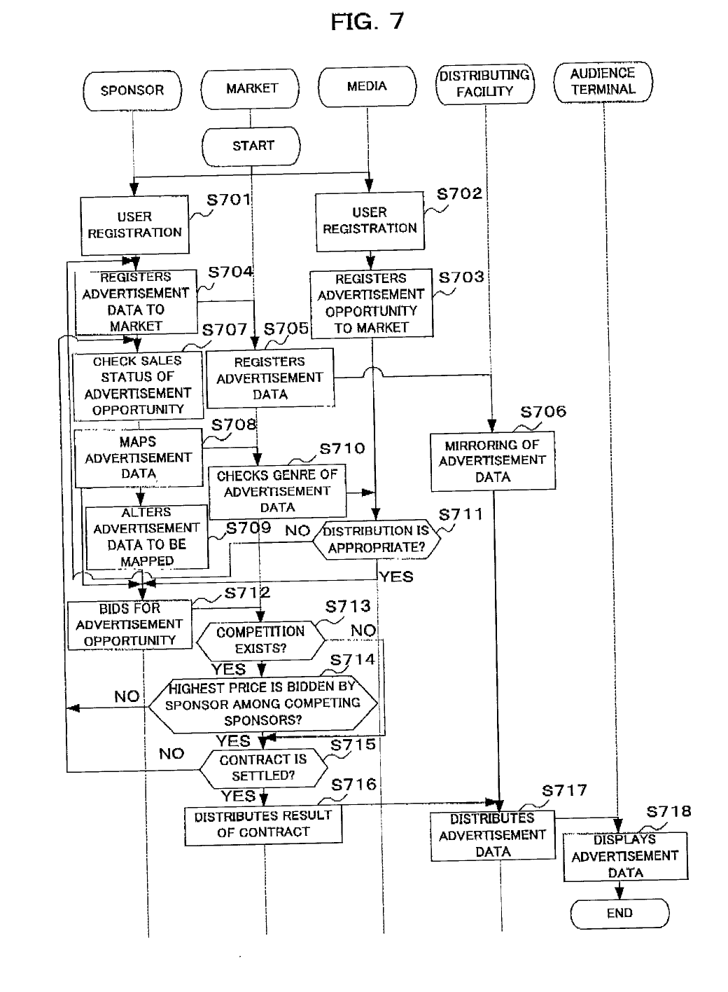

The operation of the advertisement opportunity trading system according to this embodiment will now be specifically explained with reference to the drawings. FIG. 7 is a flowchart for explaining the process performed by the advertisement opportunity trading system according to this embodiment.

The sponsor registers the user information 50 (sponsor-side user information) to the market controller 100 by the sponsor-side terminal 30 (step S701). The media registers the user information 50 (media-side user information) to the market controller 100 by the media-side terminal 40 (step S702).

The media registers the advertisement opportunity information 60 to the market controller 100 by the media-side terminal 40 (step S703). The sponsor registers the advertisement data information 80 to the market controller 100 (and the market-use advertisement data storage unit 114) by the sponsor-side terminal 30 (step S704 and step S705). At this time, the advertisement data mirroring unit 157 make the data stored in the distributing-purpose advertisement data storage unit 12 mirror the data stored in the market-use advertisement data storage unit 114 (step S706).

Then, the sponsor obtains a list of the advertisement opportunity information 60 and a list of the trading status information 70 by the sponsor-side terminal 30 and checks the sales status of the registered advertisement opportunities (step S707). The sponsor selects an advertisement opportunity, and maps the mapping advertisement data ID 73-1 in the trading status information 70 having an advertisement opportunity ID 71 of the selected advertisement opportunity by the sponsor-side terminal 30 (step S708). At this time, the sponsor can temporarily register a plurality of advertisement data as the candidate to be mapped as the mapping advertisement data ID 73-1 in the spare mapping advertisement data ID list 73-2. Later on, the sponsor designates advertisement data which the sponsor actually wants to map as the mapping advertisement data ID 73-1 from the list 73-2.

After the mapping of advertisement data is performed by the sponsor, the advertisement data check unit 155 compares the genre information list 73-3 of the listed advertisement data with the prohibited genre information 66 to check the genres of the listed advertisement data (step S710). When check of the genres of the listed advertisement data is completed, the media determines whether the distribution of the advertisement data is appropriate or not (step S711). Since the advertisement data check unit 155 checks the genres of the advertisement data before the media determines whether the distribution of the advertisement data is appropriate or not as described above, the media's determination can be simplified.

If it is before the sponsor makes a bid for the advertisement opportunity ID 71, the sponsor can alter advertisement data which is referred to as the mapping advertisement data ID 73-1 to another advertisement data listed on the spare mapping advertisement data ID list 73-2 regardless of whether it is before or after the media determines whether the distribution of advertisement data is appropriate or not (step S709).

The trading information process unit 161 determines whether or not the media determines in step S711 that the distribution of advertisement data is appropriate. In a case where the trading information process unit 161 determines that the media determines that the distribution is inappropriate (step S711: NO), the process flow returns to step S704. Because of this, the sponsor cannot make a bid for the currently selected advertisement opportunity ID 71, and thus should reregister the advertisement data information 80 to the market controller 100 by the sponsor-side terminal 30.

On the other hand, in a case where the trading information process unit 161 determines that the media determines that the distribution is appropriate (step S711: YES), the sponsor can make a bid for the advertisement opportunity ID 71 (step S712).

When making a bid, the price presented by the sponsor using the sponsor-side terminal 30 is recorded as the bid price 74-2 in a bid log 74 together with the sponsor-side user ID 74-1.

In a case where a plurality of sponsors bid for a same advertisement opportunity, the business category 55 of the sponsor might be the same as that of other sponsors (in other words, a competition might be caused). To avoid this, the competition check unit 162 obtains the business category 55 of each bidding sponsor, and determines whether competition exists or not by comparing the obtained business categories 55 (step S713).

In a case where the competition check unit 162 determines that a competition exists (step S713: YES), the competition check unit 162 determines whether or not the highest bid price is presented by the sponsor who competes with others (whether or not the sponsor who competes with others bids the highest price) (step S714). In a case where the competition check unit 162 determines that the sponsor who competes with others bids the highest price (step S714: YES), the competition check unit 162 writes “competition existing, closing of contract possible” in the competition status 74-3 corresponding to the sponsor-side user ID 74-1 of the sponsor who bids the highest price. In a case where the competition check unit 162 determines that the sponsor who competes with others does not bid the highest price (step S714: NO), the competition check unit 162 writes “competition existing, closing of contract impossible” in the competition status 74-3 of the sponsor. Then, the process flow returns to step S707.

On the other hand, in a case where the competition check unit 162 determines that no competition exists (step S713: NO), the competition check unit 162 writes “no competition, closing of contract possible” in the competition status 74-3 of all the sponsors who make a bid. Then, the process flow goes to step S715.

Then, the trading information process unit 161 determines whether or not a contract is settled (step S715). In a case where the trading information process unit 161 determines that a contract is not settled (step S715: NO), the process flow returns to step S707.

On the other hand, in a case where the trading information process unit 161 determines that a contact is settled (step S715: YES), the trading information process unit 161 transmits a result of the settled contract to the advertisement data distribution unit 156. And the mapping advertisement data ID 73-1 of the sponsor who has settled the contract is copied to the settled advertisement data ID list 75. Then, the advertisement data distribution unit 156 distributes the advertisement opportunity ID 62, the settled advertisement data ID list 75, the display staring time 64-1, the display ending title 64-2, and the number of sponsors acceptable 65-3 to the advertisement distribution process unit 11 as the result of the contract (step S716).

The advertisement distribution process unit 11, which has received the result of the contract, obtains the number (designated by the number of sponsors acceptable 65-3) of advertisement data which are listed on the settled advertisement data ID list 75 from the distributing-purpose advertisement data storage unit 12, and distributes the obtained advertisement data to the reception unit 21 of the audience terminal 20 via the media who holds the settled advertisement opportunity ID 62 during a period of time determined by the display starling time 64-1 and the display ending time 64-2 (step S717).

Since the data in the distributing-purpose advertisement data storage unit 12 mirrors the data in the market-use advertisement data storage unit 114, there is no need to transfer the advertisement data contents 84 from the market-user advertisement data storage unit 114, and thus, large time delay is not caused in the distribution process. Therefore, it is possible to distribute advertisement data immediately after a contract is settled in the market, for example.

The reception unit 21 of the audience terminal 20 receives the number (designated by the number of sponsors acceptable 65-3) of advertisement data which are listed on the settled advertisement data ID list 75 from the advertisement distribution process unit 11, and transmits the received data to the display unit 22. When the display unit 22 receives the number (designated by the number of sponsors acceptable 65-3) of advertisement data which are listed on the settled advertisement data ID list 75 from the reception unit 21, the display unit 22 displays the received data (step S718).

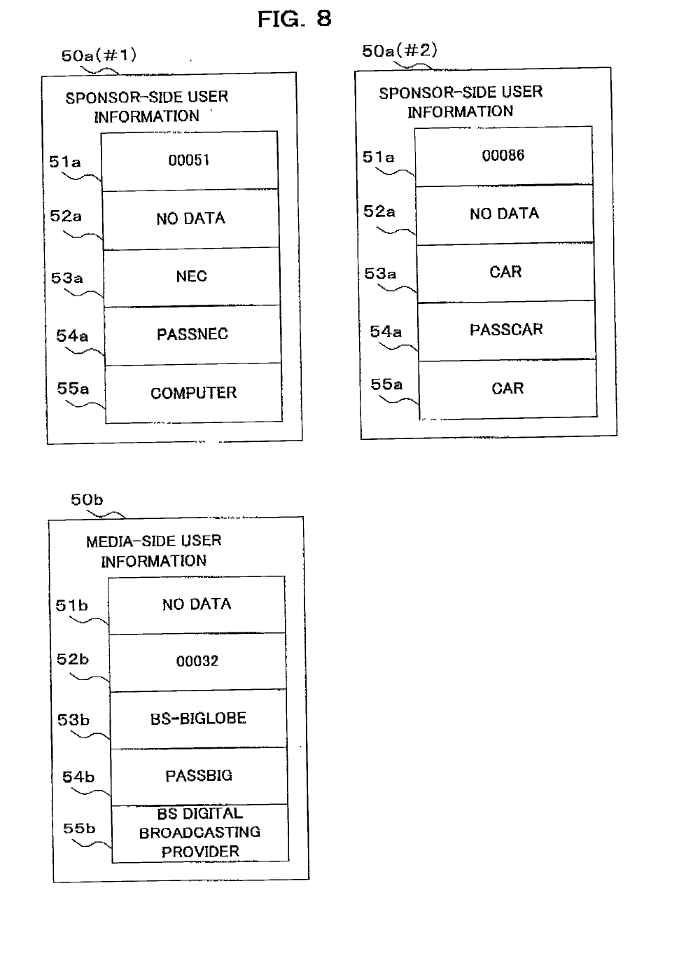

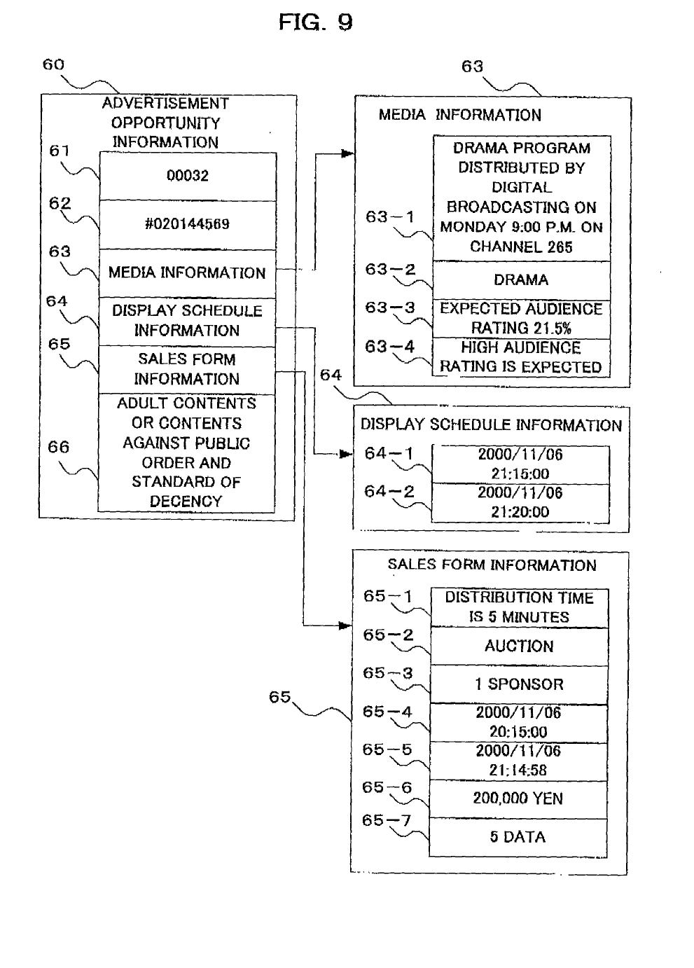

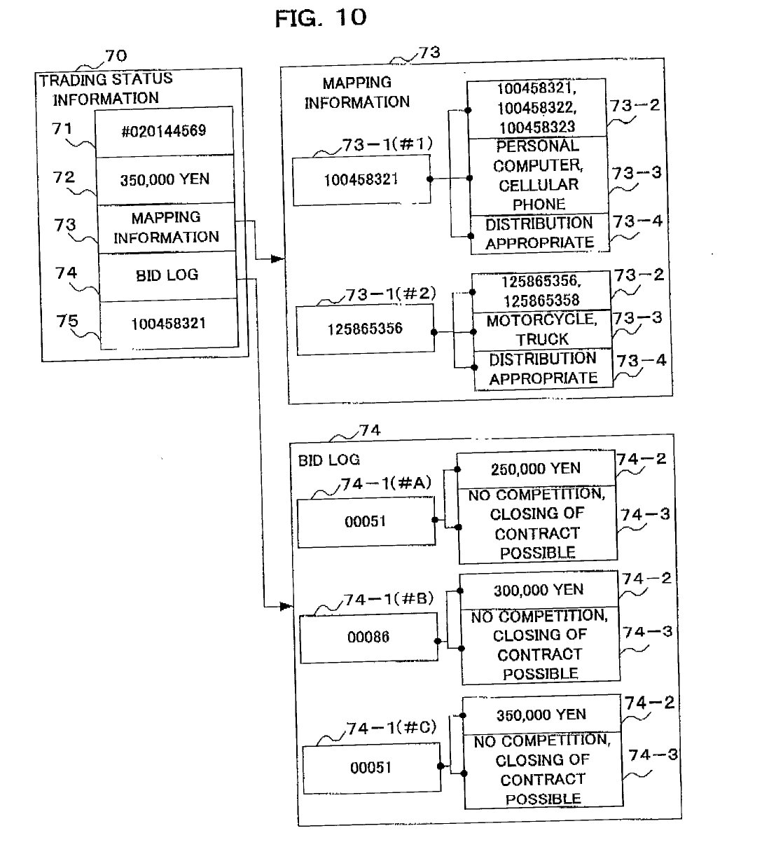

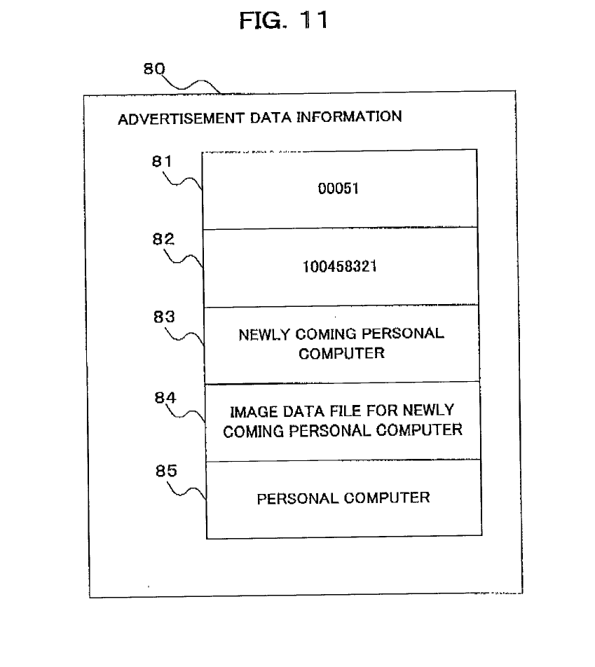

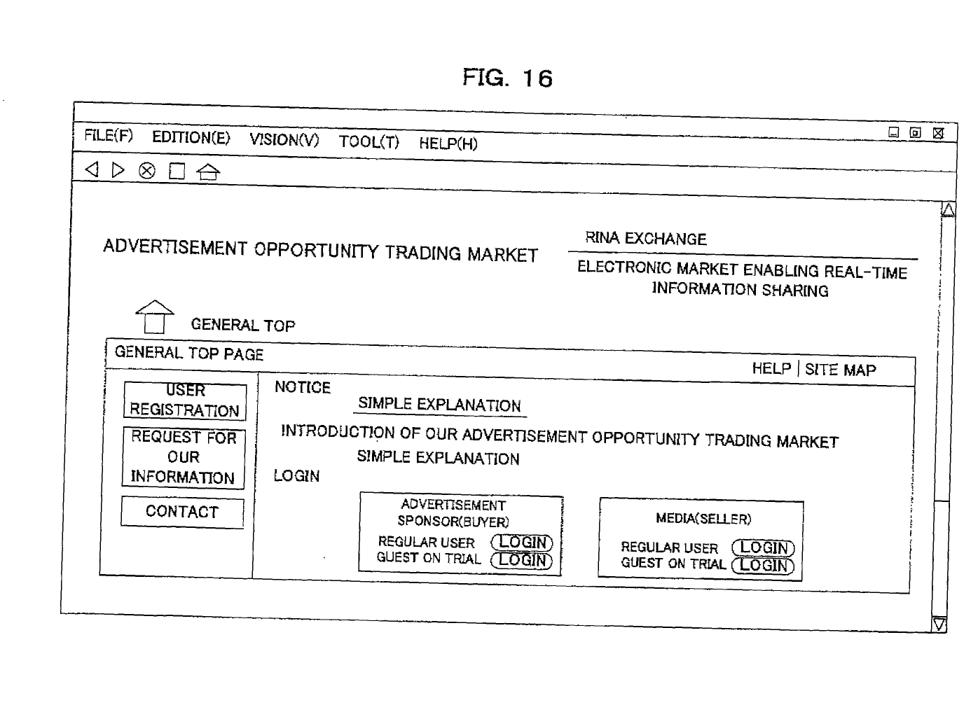

The process performed by the advertisement opportunity trading system according to this embodiment will be explained by employing a specific example. FIG. 8 to FIG. 11 are diagrams exemplifying the data according to this embodiment. FIG. 8 exemplifies the user information 50. FIG. 9 exemplifies the advertisement opportunity information 60. FIG. 10 exemplifies the trading status information 70. FIG. 11 exemplifies the advertisement data information 80. FIG. 16 to FIG. 23 are diagrams exemplifying display screens of a web site operated by an advertisement opportunity trading market.

When a sponsor connects to the web site operated by the advertisement opportunity trading market by the sponsor-side terminal. 30, the screen shown in FIG. 16 is displayed. When the sponsor selects “user registration” displayed on the screen shown in FIG. 16, the screen shown in FIG. 17 is displayed. The sponsor registers user information 50a to the user information process unit 130 from the screen shown in FIG. 17. The user information process unit 130 employs a number as a user ID 51a of the registered sponsor-side user information 50a (step S701).

In this example, the user information process unit 130 receives user information including a user name 53a “NEC” and a business category 55a “computer” as shown by the sponsor-side user information 50a (#1) in FIG. 8, and employs a number “00051” as the sponsor-side user ID 51a.

A media registers media-side user information 50b to the user information. process unit 130 by the media-side terminal 40. The media-side user information 50b is also registered by connecting to the web site run by the advertisement opportunity trading market. The user information process unit 130 employs a number as a user ID 52b of the registered media-side user information 50a (step S702).

In this example, the user information process unit 130 receives the user information 50b including a user name 53b “BS-BIGLOBE” and a business category 55b “BS digital broadcasting provider” as shown in FIG. 8, and employs a number “00032” as the media-side user ID 52b.

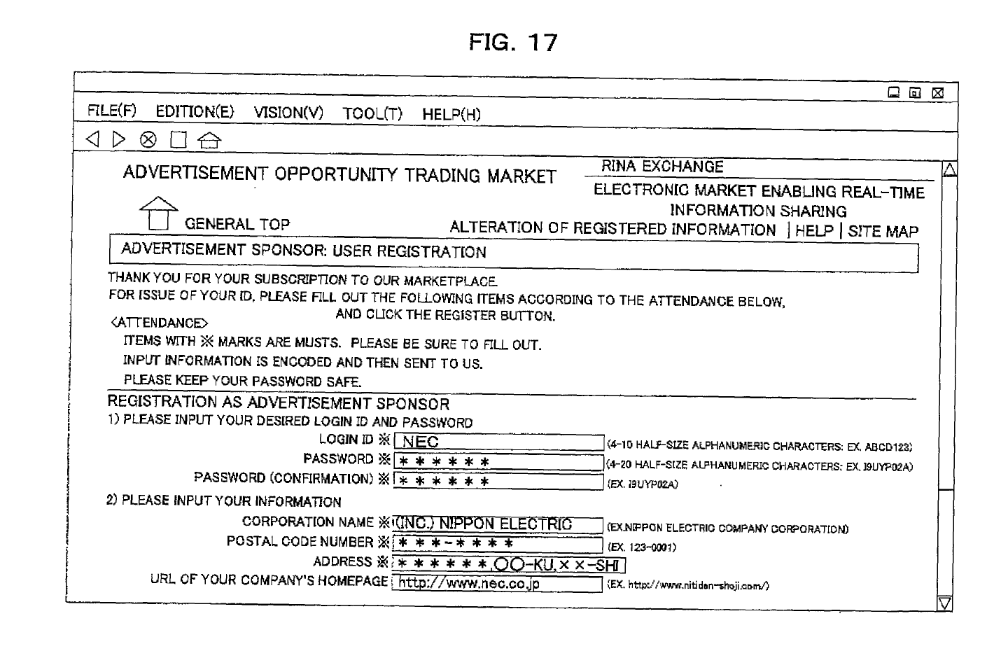

The media registers the advertisement opportunity information 60 to the market controller 100 by the media-side terminal 40 according to the procedure shown in FIG. 18 (step S703).

In this example, the details of the registered advertisement opportunity information 60 having the advertisement opportunity ID 62 are shown in FIG. 9 as follows.

The media is “a drama program distributed by BS digital broadcasting and expecting a high audience rating”.

The period of time for distributing advertisement data to audiences is “5 minutes” within the period of time prepared for the program.

The sales form is “auction”.

Only “1 sponsor” can settle a contract for this advertisement opportunity”.

The auction time starts “1 hour before” the distribution of advertisement data to audiences, and ends “immediately before (2 seconds before)” the distribution.

The starting price of the auction is “200,000 yen”.

The maximum number of spare mapping advertisement data registerable by a sponsor is “5”.

The trading status information 70 is generated in the market controller 100, and initialized. Immediately after the generation of the trading status information 70, price information 72 is registered as “200,000 yen”, same as the starting price of the auction. No data is registered in the mapping information 73, the bid log 74, and the settled advertisement data ID list 75.

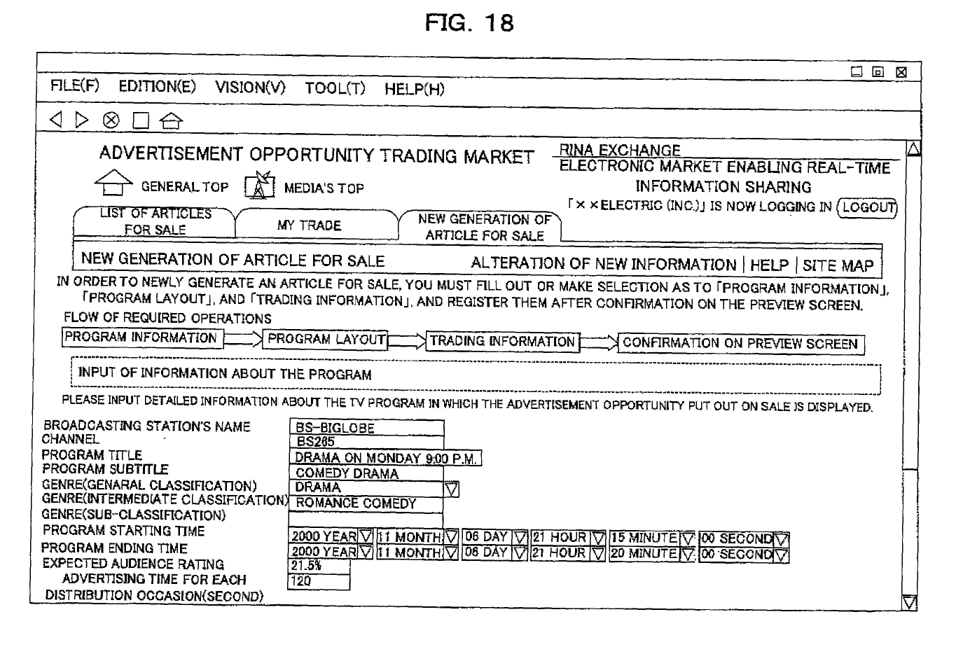

The sponsor registers the advertisement data information 20 to the market controller 100 (the market-use advertisement exit data storage unit 114) by the sponsor-side terminal 30 as shown in FIG. 19 (step S704 and step S705).

In this example, the genre information 85 related to the registered advertisement data ID 82 is a personal computer as shown in FIG. 11. The sponsor may register a plurality of advertisement data at a time for the spare mapping advertisement data.

When the advertisement data information 80 is registered, the advertisement data mirroring unit 157 makes the data in the distributing-purpose advertisement data storage unit 12 mirror the data in the market-use advertisement data storage unit 114 (step S706).

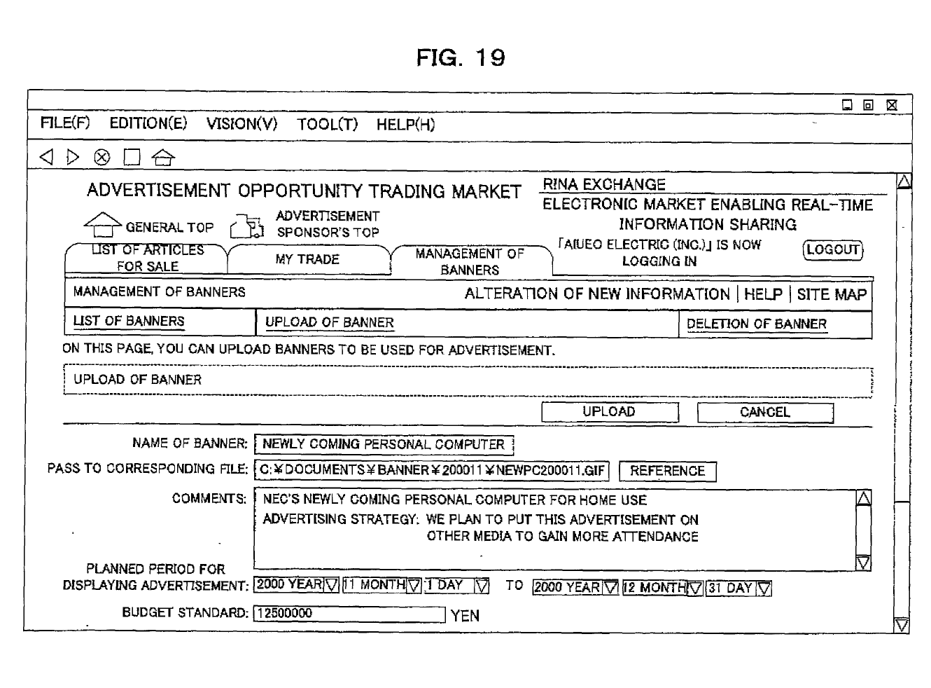

The sponsor obtains the advertisement opportunity information 60 and the trading status information 70 as shown in FIG. 20 by the sponsor-side terminal 30, and checks the sales status of the advertisement opportunities (stop S707).

The sponsor selects a predetermined advertisement opportunity by the sponsor-side terminal 30, and maps the mapping advertisement data ID 73-1 in the trading status information 70 having an advertisement opportunity ID 71 of the selected advertisement opportunity (step S708).

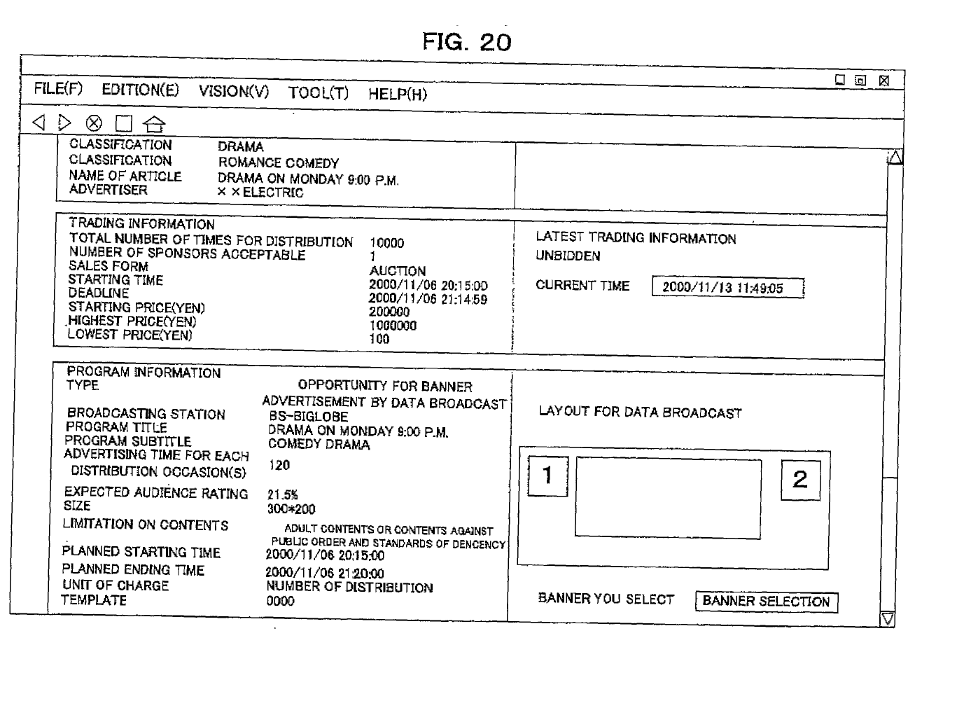

In this example, as shown in FIG. 10, the sponsor selects the three advertisement data 100458321, 100458322, and 100458323 from the six advertisement data shown in FIG. 21, and registers the selected advertisement data in the spare mapping advertisement data ID list 73-2. Then, the sponsor designates one advertisement data which the sponsor actually wants to map as the mapping advertisement data ID 73-1. At this stage, the advertisement data having the advertisement data 100458321 is registered as the mapping advertisement data ID 73-1.

In this example, another sponsor belonging to an automobile industry indicated by the sponsor-side user information 50a (#2) shown in FIG. 9 registers two advertisement data as the spare mapping advertisement data in the mapping information 73.

The advertisement data check unit 155 compares the genre information list 73-3 for the advertisement data listed on the spare mapping advertisement data ID list 73-2 in the mapping information 73 with the prohibited genre information 66, before the media determines whether the distribution of the advertisement data is appropriate or not. This comparison is done for each of the sponsors (#1 and #2). If any prohibited genre is found in the genre information list 73-3, the advertisement data check unit 155 writes “prohibited genre existing” beside the found genre information (step S710).

In this example, there is no genre information corresponding to the prohibited genre. However, if “cellular phone” is prohibited by the prohibited genre information 66 (if “cellular phone” is indicated in the prohibited genre information 66 shown in FIG. 9), the content of the genre information list 73-3 shown in FIG. 10 is represented as “personal computer (no prohibited genre)/cellular phone (prohibited genre existing)”. When the media determines whether the distribution of advertisement data is appropriate or not, the media only needs to check the genre information list 73-3 for each sponsor. Therefore, determination of whether the distribution of the advertisement data is appropriate or not performed by the media is simplified.

The media determines whether the distribution of the advertisement data listed on the spare mapping advertisement data ID list 73-2 of each of (#1) and (#2) is appropriate or not (step S711). In a case where determined that the distribution of the advertisement data is appropriate (step S711: YES), the trading information process unit 161 writes “distribution appropriate” in the distribution information 73-4 for each of (# 1) and (#2). In a case where determined that the distribution of the advertisement data is inappropriate (step S711: NO), the trading information process unit 161 writes “distribution inappropriate” in the distribution information 73-4. The sponsor whose advertisement data is determined as “distribution inappropriate” cannot bid for the advertisement opportunity. In this case, the process flow returns to step S704, and the sponsor needs to reregister the advertisement data information 80 to the market controller 100.

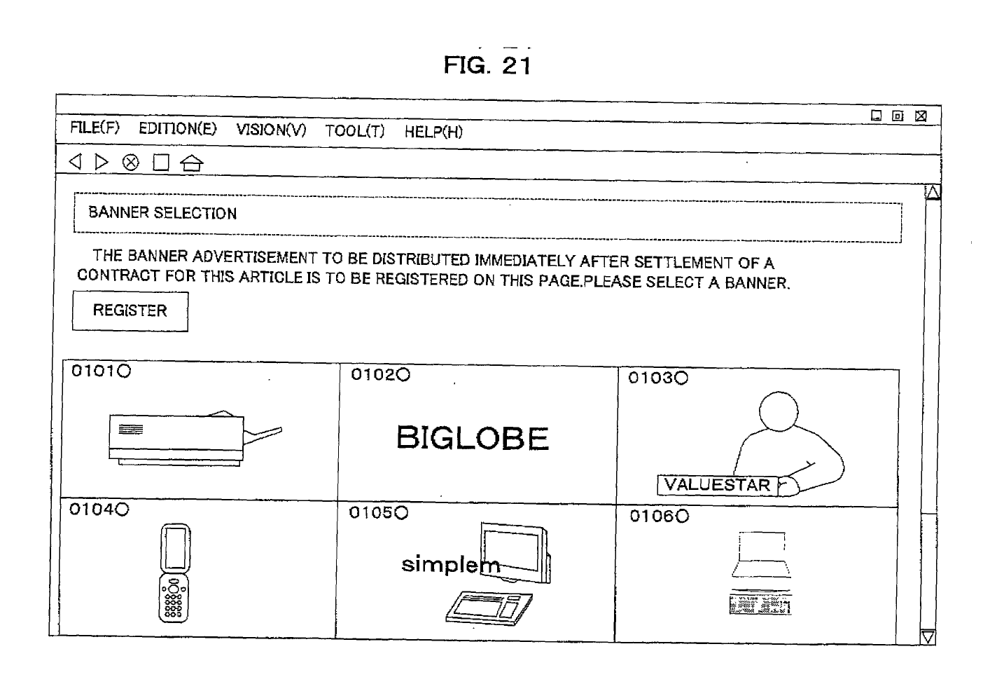

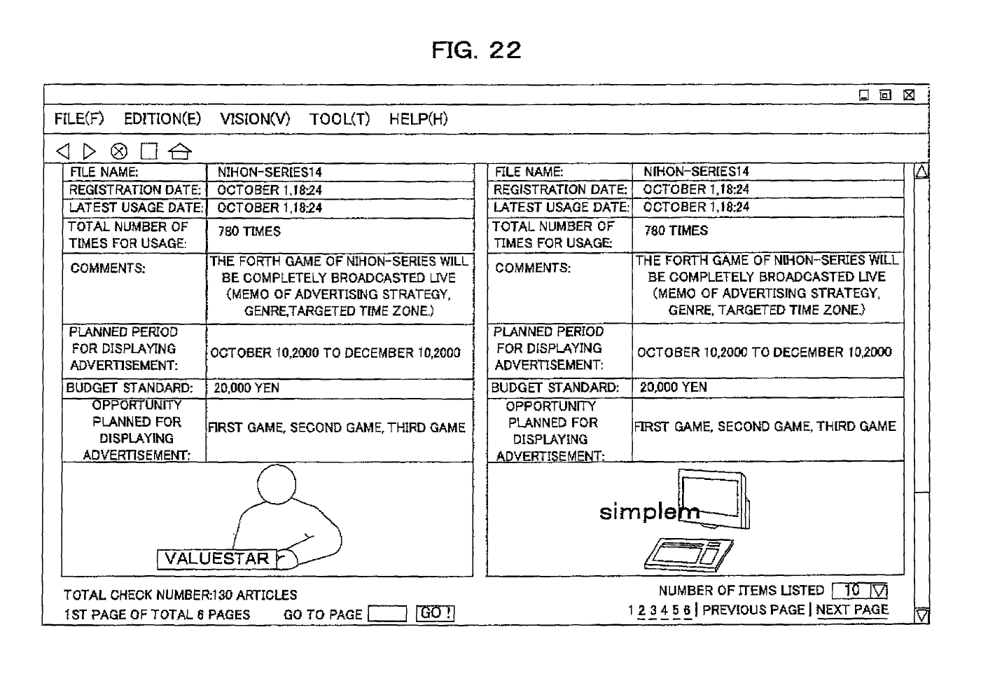

If it is before the sponsor makes a bid for the advertisement opportunity, the sponsor can alter advertisement data which is referred to as the mapping advertisement data ID 73-1 to another advertisement data listed on the spare mapping advertisement data ID list 73-2 as shown in FIG. 22, regardless of whether it is before or after the media determines whether the distribution of advertisement data is appropriate or not (step S709).

The sponsor whose advertisement data is determined as “distribution appropriate” makes a bid for the advertisement opportunity (step S712). For example, if the sponsor (#1) bids 250,000 yen for the advertisement opportunity, the result is recorded in the first bid log 74 (#A). Specifically, the “sponsor-side user ID 81 (00051)” is registered in the item “sponsor-side user ID 74-1”, and “250,000 yen” is registered in the item “bid price 74-2”.

When the sponsor makes a bid for the advertisement opportunity, the competition check unit 162 checks whether competition exists or not (step S713). At this stage, there is no other sponsor who competes with the sponsor. Therefore, the competition check unit 162 writes “no competition, closing of contract possible” in the competition status 74-3.

Then, another sponsor (#2) bids 300,000 yen for the same advertisement opportunity. The result is registered in the second bid log 74 (#B) as “00086” (sponsor-side user ID 74-1) and “300,000 yen” (bid price 74-2).

Since a plurality of sponsors make a bid for the same advertisement opportunity, the competition check unit 162 obtains the business category 55 of each of the sponsors who make a bid, and compares the obtained business categories 55 in order to determine whether competition exists or not. In this example, the business category 55a of the sponsor (#1) is “computer”, and the business category 55a of the sponsor (#2) is “car”. Therefore, there is no competition existing. Thus, the competition check unit 162 writes “no competition, closing of contract possible” in the competition status 74-3 of each of the bid logs (#A) and (#B).

Then, the sponsor (#1) bids 350,000 yen for the same advertisement opportunity for the second time. The result is registered in the third bid log 74 (#C) as “00051” (sponsor-side user ID 74-1) and “350,000 yen” (bid price 74-2).

The competition check unit 162 checks the competition status. Since there is no competition existing, the competition check unit 162 writes “no competition, closing of contract possible” in the competition status 74-3 of each of the bid logs (#A), (#B), and (#C). Since there is no competition, the sponsor skips step S714 and goes to step S715.

The sponsor who presents the highest price at the time the sales ending time 65-5 comes is the sponsor (#1), and the bid price 74-2 presented by the sponsor (#1) is “350,000 yen”. And since the number of sponsors acceptable 65-3 is “1”, the sponsor (#1) is determined as the successful bidder (step S715). The trading information process unit 161 processes the result of this bidding and settlement of a contract.

At the time of this settlement of the bidding, the mapping advertisement data ID 73-1 (100458321) of the successfully bidding sponsor (#1) is copied to the settled advertisement data ID list 75.

Once a contract is settled, the advertisement data distribution unit 156 distributes the advertisement opportunity ID 62, the settled advertisement data ID list 75, the display starting time 64-1, the display ending time 64-2, and the number of sponsors acceptable 65-3 to the advertisement distribution process unit 11 as the result of the settled contract (step S716).

The advertisement distribution process unit 11, which has received the result of the settled contract, obtains the number (designated by the number of sponsors acceptable 65-3) of advertisement data which are listed the settled advertisement data ID list 75 from the distributing-purpose advertisement data storage unit 12, and distributes the obtained advertisement data to the reception unit 21 of the audience terminal 20 via the media who holds the settled advertisement opportunity ID 62 during a period of time determined by the display starting time 64-1 and the display ending time 64-2 (step S717).

At this time, since the data in the distributing-purpose advertisement data storage unit 12 mirrors the data in the market-use advertisement data storage unit 114, there is no need to transfer the advertisement data contents 84 from the market-use advertisement data storage unit 114. Thus, no large time delay is caused in the distribution process, and it is possible to distribute the advertisement data immediately after a contract is settled in the market.

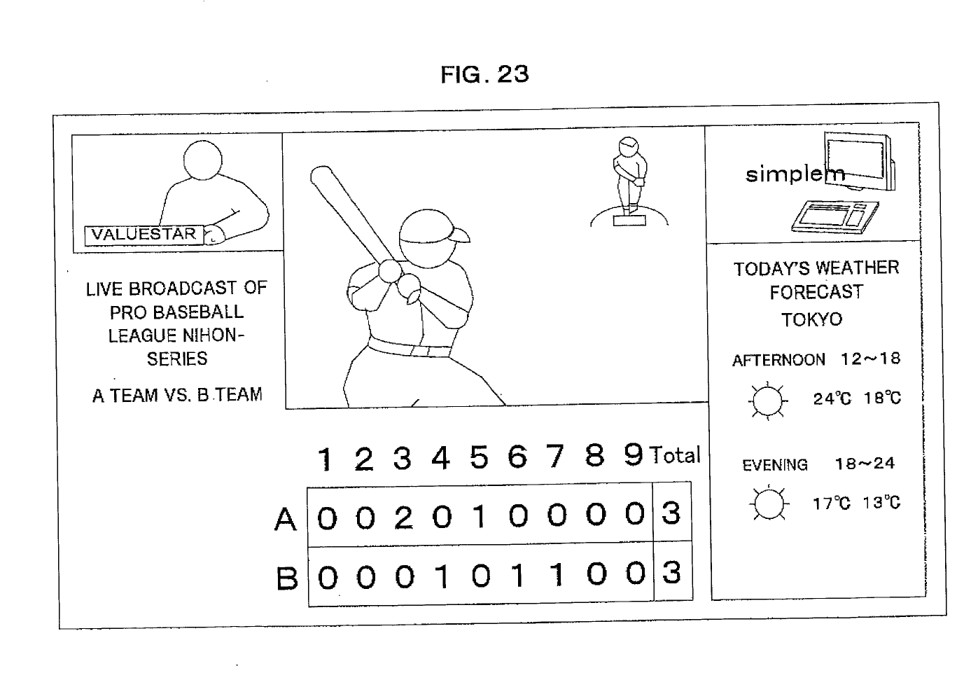

The reception unit 21 of the audience terminal 20 receives the number (designated by the number of sponsors acceptable 65-3) or advertisement data which are listed on the settled advertisement data ID list 75 from the advertisement distribution process unit 11, and transmits the received advertisement data to the display unit 22. When the display unit 22 receives the number (designated by the number of sponsors acceptable 65-3) of advertisement data which are listed on the settled advertisement data ID list 75 from the reception unit 21, the display unit 22 displays the received data, as shown in FIG. 23 (step S718).

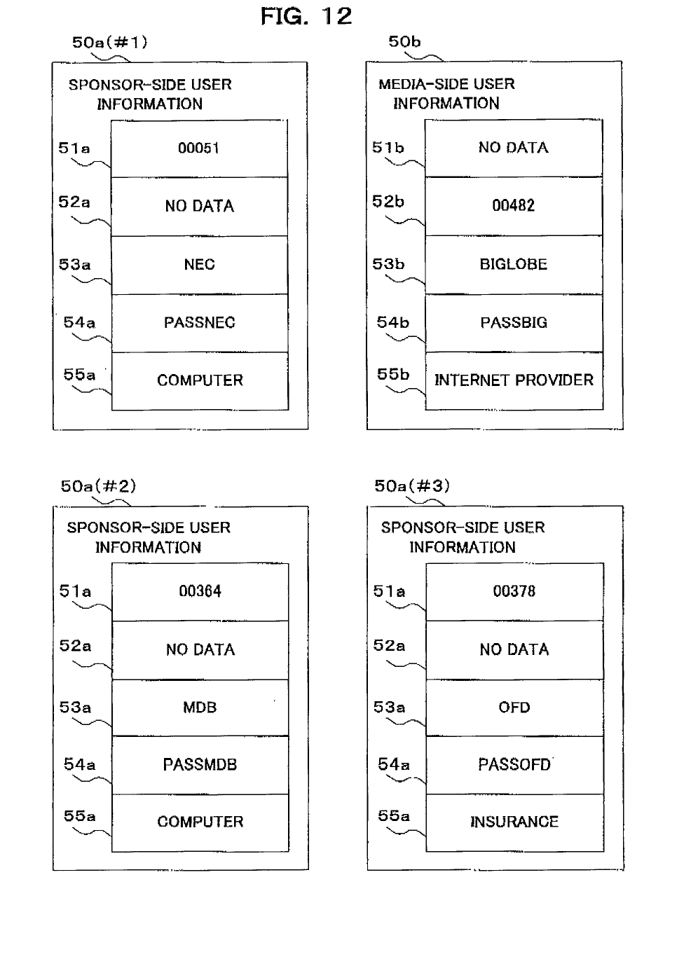

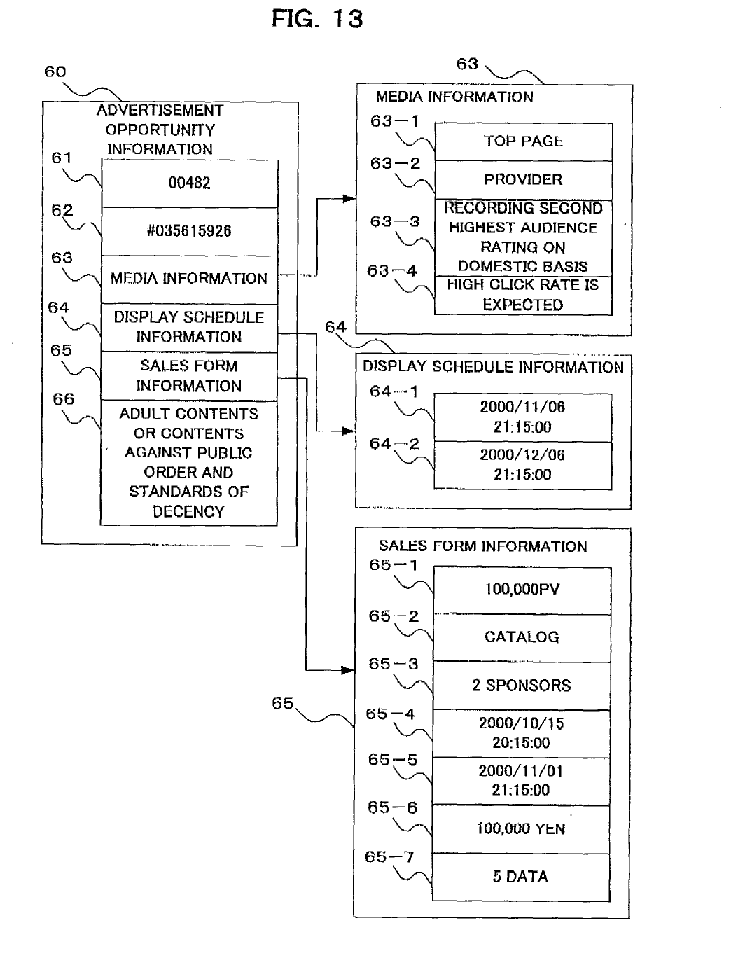

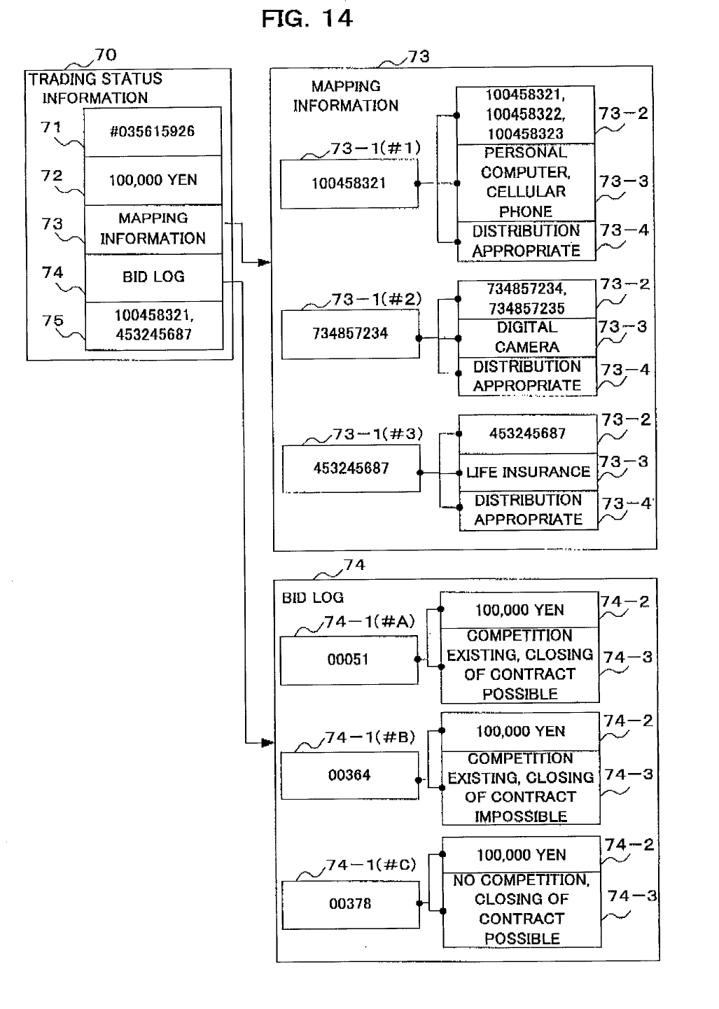

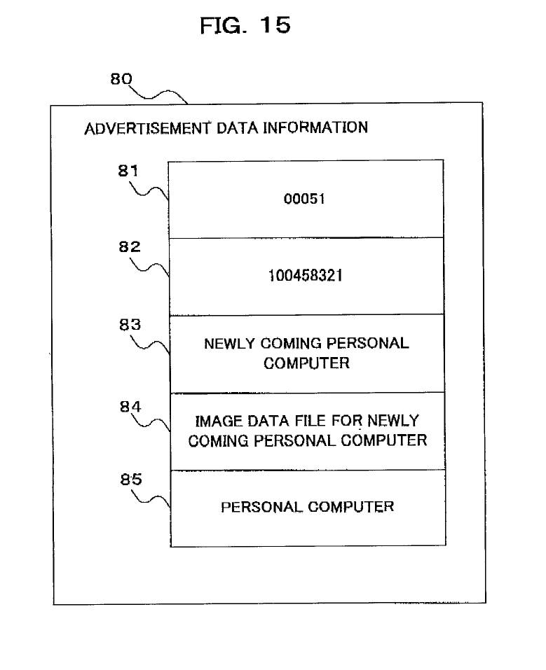

The process performed by the advertisement opportunity trading system according to this embodiment will he explained by employing another example. FIG. 12 to FIG. 15 are diagrams exemplifies the data according to this embodiment. FIG. 12 exemplifies the user information 50. FIG. 13 exemplifies the advertisement opportunity information 60. FIG. 14 exemplifies the trading status information 70. FIG. 15 exemplifies the advertisement data information 80.

Each sponsor registers the user information 50a to the user information process unit 130 by the sponsor-side terminal 30. The user information process unit 130 employs a number as a user ID 51a of the registered sponsor-side user information 50a (step S701).

In this example, the user information process unit 130 receives the sponsor-side user information 50a including a user name 53a “NEC” and a business category 55a “computer” as shown by the sponsor-side user information 50a (#1) in FIG. 12, and employs a number “00051” as the sponsor-side user ID 51a.

And the user information process unit 130 receives the sponsor-side user information 50a including a user name 53a “MDB” and a business category 55a “computer” as shown by the sponsor-side user information 50a (#2) in FIG. 12, and employs a number “00364” as the sponsor-side user ID 51a.

Further, the user information process unit 130 receives the sponsor-side user information 50a including a user name 53a “OFD” and a business category 55a “insurance” as shown by the sponsor-side user information 50a (#3) in FIG. 12, and employs a number “00378” as the sponsor-side user ID 51a.

The media registers the media-side user information 50b to the user information process unit 130 by the media-side terminal 40. The user information process unit 130 employs a number as a user ID 52b of the registered media-side user information 50b (step S702).

In this example, the user information process unit 130 receives the media-side user information 50b including a user name 53b “BIGLOBE” and a business category 55b “internet provider” as shown in FIG. 12, and employs a number “00482” as the media-side user ID 52b.

The media registers the advertisement opportunity information 60 to the market controller 100 by the media-side terminal 40 (step S703).

In this example, the details of the registered advertisement opportunity information 60 having the advertisement opportunity ID 62 are shown in FIG. 13 as follows.

The media is a “web page” on the Internet run by BIGLOBE.

The period or time for distributing the advertisement data to audiences is “1 month”.

The sales form is “fixed price sale by catalog”.

“2 sponsors” can settle a contract for this advertisement opportunity.

The sales are closed “5 days before” the advertisement data is distributed to audiences.

The price is fixed at “100,000 yen” for catalog sale (unlike the auction, the price once registered is not fluctuated according to fixed price sale by catalog).

The maximum number of spare mapping advertisement data registerable by a sponsor is “5”.

The trading status information 70 is generated in the market controller 100, and initialized.

Each sponsor registers the advertisement data information 80 to the market controller 100 (the market-use advertisement data storage unit 114) by the sponsor-side terminal 30 (step S704 and step S705).

In this example, the genre information 85 related to the advertisement data ID 82 registered by the sponsor (#1) is a “personal computer”, as shown in FIG. 11. The sponsor (#1) may register a plurality of other advertisement data (relating to a cellular phone, for example) at a time for the spare mapping advertisement data. In the same way, the sponsors (#2) and (#3) register the advertisement data information 80.

When the advertisement data information 80 is registered, the advertisement data, mirroring unit 157 makes the data in the distributing-purpose advertisement data storage unit 12 mirror the data in the market-use advertisement data storage unit 114 (step S706).

Each sponsor obtains the advertisement opportunity information 60 and the trading status information 70 by the sponsor-side terminal 30, and checks the sales status of the advertisement opportunities (step S707).

Each sponsor maps the mapping advertisement data ID 73-1 in the trading status information 70 having an advertisement opportunity ID 71 of a selected advertisement opportunity (step S708).

In this example, as shown in FIG. 14, the sponsor (#1) registers three advertisement data in the spare mapping advertisement data ID list 73-2 (#1). Then, the sponsor (#1) selects advertisement data which the sponsor (#1) actually wants to map as the mapping advertisement data ID 73-1 from the registered advertisement data. At this stage, the advertisement data 100458321 is registered as the mapping advertisement data ID 73-1.

The sponsor (#2) registers two advertisement data both relating to a digital camera in the spare mapping advertisement data ID list 73-2 (#2). The sponsor (#3) registers one advertisement data relating to life insurance in the spare mapping advertisement data ID list 73-2 (#3).

The advertisement data check unit 155 compares the genre information list 73-3 for the advertisement data on the spare mapping advertisement data ID list 73-2 registered in the mapping information 73 with the prohibited genre information 66 before the media determines whether the distribution of the advertisement data is appropriate or not (step S710). This comparison is done for each of the sponsors (#1) to (#3). In this example, there is no advertisement data corresponding to the prohibited genre.

When the media determines whether the distribution of the advertisement data is appropriate or not by the media-side terminal 40, the media only need is to check the genre information list 73-3 for each of the sponsors (#1) to (#3). Therefore, the determination of whether the distribution of the advertisement data is appropriate or not performed by the media will be simplified.

The media determines whether the distribution of the advertisement data on the spare mapping advertisement data ID list 73-2 of each of the sponsors (#1) to (#3) is appropriate or not (step S711). In this example, the advertisement data of all the sponsors are determined as “distribution appropriate”, as indicated in the distribution information 73-4 in FIG. 14.

The sponsor whose advertisement data is determined as “distribution appropriate” can bid for the selected advertisement opportunity (step S712). For example, if the sponsor (#1) requests this advertisement opportunity at the price of “100,000 yen”, the result is registered in the bid log 74 (#A). Specifically, the “sponsor-side user ID 51a (00051)” is registered in the sponsor-side user ID 74-1, and “100,000 yen” is registered in the bid price 74-2. When the sponsor (#1) makes a bid for this advertisement opportunity, the competition check unit 162 checks whether competition exists or not (step S713). At this stage, there is no other sponsor who competes with the sponsor (#1), the competition check unit 162 writes “no competition, closing of contract possible” in the competition status 74-3.

If the sponsor (#2) requests the same advertisement opportunity (the advertisement opportunity having the same advertisement opportunity ID 71 (00482)) at the price of “100,000 yen”, the result is registered in the bid log 74 (#B). Specifically, the “sponsor-side user ID 51a (000364)” is registered in the sponsor-side user ID 74-1 and “100,000 yen” is registered in the bid price 74-2. In this case, since a plurality of sponsors bid for the same advertisement opportunity, the competition check unit 162 obtains the business category 55 of each of the bidding sponsors, and compares the obtained business categories 55 in order to determine whether competition exists or not. In this example, the business category 55 of the sponsor (#1) is “computer”, and the business category 55 of the sponsor (#2) is also “computer”. Thus, those sponsors (#1) and (#2) compete with each other. If it is provided that a sponsor who makes a bid first is entitled to successfully bid for the advertisement opportunity in a case where competition exists, the sponsor (#2) cannot buy this advertisement opportunity. In this case, the competition check unit 162 writes “competition existing, closing (if contract possible” in the competition status 74-3 of the sponsor (#1), and writes “competition existing, closing of contract impossible” in the competition status 74-3 of the sponsor (#2).

If the sponsor (#3) requests to buy the same advertisement opportunity at the price of “100,000 yen”, the result is registered in the bid log 74 (#C). Specifically, the “sponsor-side user ID 51a (000378)” is registered in the sponsor-side user ID 74-1, and “100,000 yen” is registered in the bid price 74-2. Also in this case, a plurality of sponsors bid for the same advertisement opportunity. Therefore, the competition check unit 162 obtains the business category 55 of each of the bidding sponsors, and compares the obtained business categories 55 to determine whether competition exists or not. In this example, the business category 55 of the sponsor (#1) is “computer” and the business category 55 of the sponsor (#3) is “insurance”. Therefore, competition does not exist. Thus, the competition check unit 162 writes “no competition, closing of contract possible” in the competition status 74-3 of the sponsor (#3). Since there is no competition, the sponsor (#3) skips step S714 and goes to step S715.

The sponsors (#1) and (#3) are determined as “closing of contract possible” when the sales ending time 65-5 comes, and the number of sponsors acceptable 65-3 is “2”. Therefore, the two sponsor (#1) and (#3) close the contract for this advertisement opportunity (step S715). At this time, the mapping advertisement data IDs 73-1 of both of the sponsors (#1) and (#3) are copied to the settled advertisement data ID list 75.

When the contract is settled, the advertisement data distribution unit 156 distributes the advertisement opportunity ID 62, the settled advertisement data ID list 75, the display starting time 64-1, the display ending time 64-2, and the number of sponsors acceptable 65-3 to the advertisement distribution process unit 11 as the result of the contract (step S716).

The advertisement distribution process unit 11, which has received the result of the settled contract, obtains the number (designated by the number of sponsors acceptable 65-3) of advertisement data which are listed on the settled advertisement data ID list 75 from the distributing-purpose advertisement data storage unit 12, and distributes the obtained advertisement data to the reception unit 21 of the audience terminal 20 via the media who holds the settled advertisement opportunity ID 62 during a period of time determined by the display starting time 64-1 and the display ending time 64-2 (step S717).

At this time, since the data in the distributing-purpose advertisement data storage unit 12 mirrors the data in the market-use advertisement data storage unit 114, there is no need to transfer the advertisement data contents 84 from the market-use advertisement data storage unit 114. Therefore, no large time delay is caused in the distribution process, and it is possible to distribute the advertisement data immediately after the contract is settled in the market.

The reception unit 21 of the audience terminal 20 receives the number (designated by the number of sponsors acceptable 65-3) of advertisement data which are listed on the settled advertisement data ID list 75 from the advertisement distribution process unit 11, and transmits the received advertisement data to the display unit 22. When the display unit 22 receives the number (designated by the number of sponsors acceptable 65-3) of advertisement data which are listed on the settled advertisement data ID list 75 from the reception unit 21, the display unit 22 displays the received data (step S718).

As obvious from the above explanation, the advertisement opportunity trading system according to this invention accomplishes the following effects.

According to the advertisement opportunity trading system of the present invention, if a sponsor wants to distribute advertisement data, media previously determines whether the distribution of the advertisement data is appropriate or not. The media accepts an application for the distribution of the advertisement data from the sponsor only in a case where the media determines that the distribution of the advertisement data is appropriate. Therefore, sponsors can continue their bidding until immediately before the time for distributing advertisement data comes. Further, it is possible to distribute advertisement data of a sponsor at the same time the sponsor successfully bids for an advertisement opportunity.

According to the advertisement opportunity trading system of the present invention, before a sponsor buys or bids for an advertisement opportunity, media determines whether the distribution of advertisement data is appropriate or not. Therefore, even if a period of time for selling an advertisement opportunity from recruitment of sponsors to distribution of advertisement data is short, the period of time is enough for bidding process.

According to the advertisement opportunity trading system of the present invention, an apparatus of a broadcasting station, etc. which is the distributor of an advertisement, mirrors advertisement data registered by a sponsor. Therefore, it is unnecessary to transmit the advertisement data from the advertisement opportunity trading system to the broadcasting station, etc. after a contract is settled, and it is possible to distribute the advertisement data immediately after a contract is settled. Thus, it is possible to continue a trade for an advertisement opportunity properly until immediately before the distribution of an advertisement starts.

According to the advertisement opportunity trading system of the present invention, a sponsor can register a plurality of advertisement data which the sponsor wants to distribute at a time, and media can determine whether the distribution of advertisement data is appropriate or not for all of the plurality of advertisement data simultaneously before bidding starts. Therefore, the sponsor can change advertisement data to actually be distributed to another distribution-appropriate advertisement data among the plurality of registered advertisement data anytime only if it is before distribution time set for the advertisement opportunity comes.

The advertisement opportunity trading system of the present invention comprises an advertisement data check unit for checking information on the genre of advertisement data registered by a sponsor. Therefore, it is possible to check by the genre information whether the advertisement data is employable for an advertisement opportunity requested by the sponsor. Due to this check, the media can easily confirm whether the genre of the advertisement data registered by the sponsor corresponds to the prohibited genre for the requested advertisement opportunity, and thus can easily determine whether the distribution of the advertisement data is appropriate or not. Therefore, even if the media registers a numerous advertisement opportunities in the market, the media can easily determine whether the distribution of advertisement data is appropriate or not for each of the numerous advertisement opportunities.

The advertisement opportunity trading system of the present invention comprises a competition check unit for checking the business category each sponsor belongs to. Therefore, a trade for an advertisement opportunity can be adjustable so that a plurality of sponsors who compete in a same business field do not bid for or buy a same advertisement opportunity at a same time, and if competing sponsors bid for a same advertisement opportunity, only one of the competing sponsors successfully bids for or buys the advertisement opportunity. Therefore, it is possible to automatically prevent advertisements of a plurality of competing sponsors from being distributed in a same program.

In the advertisement opportunity trading system according to this embodiment, the functions in the market controller 100 such as the market information process unit 120, the user information process unit 130, the advertisement opportunity process unit 140, the advertisement data control unit 150, the trading information control unit 160, etc., and functions in the advertisement distribution controller 10 such as the advertisement distribution process unit 11, etc., and other functions are realized by hardware form. Those functions can be realized by loading a computer program for executing each of those functions in a memory of a computing device. Such a computer program is stored in a recording medium 90 or 91 such as a magnetic disk, a semiconductor memory, etc. By loading the computer program in a computing device from the recording medium 90 or 91, and controlling the computing device by the program, each of the above explained functions can be realized.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to he regarded to be in the scope of the present invention.

This application is based on Japanese Patent Application No. 2000-396571 filed on Dec. 27, 2000 and including specification, claims, drawings and summary. The disclosure of the above Japanese Patent Application is incorporated herein by reference in its entirety.

What is claimed is:

1. An advertisement opportunity trading system which communicates a terminal of a sponsor of an advertisement and a terminal of media who distributes an advertisement with each other via a communication network, in order to intermediate between the sponsor and the media for facilitating a trade for an advertisement opportunity offered by the media, said system comprising:
an advertisement data reception unit which receives advertisement data from a sponsor who wants the advertisement data to be distributed on an advertisement opportunity;
an advertisement opportunity reception unit which receives an advertisement opportunity offered by media;
a distribution accepting unit which receives information representing that distribution of the advertisement data is appropriate/inappropriate from the media when the sponsor selects the advertisement opportunity received by said advertisement opportunity reception unit for distributing the advertisement data received by said advertisement data reception unit, and accepts an application for distribution of the advertisement data from the sponsor when determined that the information from the media represents that distribution is appropriate; and
a trade process unit which performs a process for trading the advertisement opportunity based on the application accepted by said distribution accepting unit.

2. The advertisement opportunity trading system according to claim 1, wherein in a case where said distribution accepting unit accepts applications for distribution of advertisement data from a plurality of sponsors for a same advertisement opportunity, said trade process unit puts up the advertisement opportunity for auction.

3. The advertisement opportunity trading system according to claim 1, further comprising:
an advertisement data registration unit which registers the advertisement data received by said advertisement data reception unit;
an advertisement opportunity registration unit which registers the advertisement opportunity received by said advertisement opportunity reception unit; and
an advertisement opportunity publicizing unit which publicizes information on the advertisement opportunity registered in said advertisement opportunity registration unit via said communication network,
wherein said distribution accepting unit accepts an application for distribution of the advertisement data registered in said advertisement data registration unit from the sponsor.

4. The advertisement opportunity trading system according to claim 3, wherein:
a plurality of advertisement data can be registered by a sponsor in said advertisement data registration unit for one advertisement opportunity; and
in a case where the media determines that the plurality of advertisement data of the sponsor are appropriate for distribution on the one advertisement opportunity, said distribution accepting unit accepts an application for distribution of one advertisement data designated by the sponsor from the plurality of advertisement data, as one to be actually distributed.

5. The advertisement opportunity trading system according to claim 4, wherein said advertisement data reception unit changes the advertisement data designated by the sponsor as one to be actually distributed with another advertisement data among the plurality of advertisement data in accordance with an instruction from the sponsor.

6. The advertisement opportunity trading system according to claim 1, wherein:
said advertisement data reception unit receives a genre of the advertisement data;
said advertisement opportunity reception unit receives a prohibited genre for designating a genre which will not be distributed on the advertisement opportunity; and
said system further comprises an advertisement data check unit which checks whether the genre of the advertisement data distribution of which on the advertisement opportunity the sponsor applies for corresponds to the prohibited genre or not, and notifies a result of checking to the media.

7. The advertisement opportunity trading system according to claim 3, wherein:
said advertisement data registration unit registers a genre of the advertisement data;
said advertisement opportunity registration unit registers a prohibited genre for designating a genre which will not be distributed on the advertisement opportunity; and
said system further comprises are advertisement data check unit which checks whether the genre of the advertisement data distribution of which on the advertisement opportunity the sponsor applies for corresponds to the prohibited genre or not, and notifies a result of checking to the media.

8. The advertisement opportunity trading system according to claim 1, further comprising a competition check unit which checks whether a plurality of sponsors compete in a same business category or not in a case where said distribution accepting unit accepts applications for distribution of advertisement data from the plurality of sponsors for one advertisement opportunity, wherein:
said competition check unit checks whether or not competition exists among the plurality of sponsors by a business category of the sponsor; and
said trade process unit permits an application for distribution of advertisement data on the advertisement opportunity from only one sponsor for each business category among the plurality of sponsors, in a case where competition among the plurality of sponsors is detected by checking of said competition check unit.

9. The advertisement opportunity trading system according to claim 3, further comprising a competition check unit which checks whether a plurality of sponsors compete in a same business category or not in a case where said distribution accepting unit accepts applications for distribution of advertisement data from the plurality of sponsors for one advertisement opportunity, wherein:
said competition check unit checks whether or not competition exists among the plurality of sponsors by a business category of the sponsor; and
said trade process unit permits an application for distribution of advertisement data on the advertisement opportunity from only one sponsor for each business category among the plurality of sponsors, in a case where competition among the plurality of sponsors is detected by checking of said competition check unit.

10. The advertisement opportunity trading system according to claim 1, further comprising an advertisement data mirroring unit which transmits advertisement data which is determined as appropriate for distribution by the media to an advertisement distribution controller which performs distribution of advertisement data, wherein:
said advertisement data mirroring unit transmits the advertisement data to said advertisement (distribution controller before a trade for an advertisement opportunity is started by said trade process unit; and
said advertisement distribution controller stores the transmitted advertisement data, and performs distribution of the stored advertisement data which is to be distributed on an advertisement opportunity, in a case where a contract for the advertisement opportunity is settled.

11. The advertisement opportunity trading system according to claim 3, further comprising an advertisement data mirroring unit which transmits advertisement data which is determined as appropriate for distribution by the media to an advertisement distribution controller which performs distribution of advertisement data, wherein:
said advertisement data mirroring unit transmits the advertisement data to said advertisement distribution controller before a trade for an advertisement opportunity is started by said trade process unit; and
said advertisement distribution controller stores the transmitted advertisement data, and performs distribution of the stored advertisement data which is to be distributed on an advertisement opportunity, in a case where a contract for the advertisement opportunity is settled.

12. A market control server which is a server apparatus for communicating a terminal of a sponsor of an advertisement and a terminal of media who distributes an advertisement with each other via a communication network, in order to intermediate between the sponsor and the media for facilitating a trade for an advertisement opportunity offered by the media, said server comprising:
an advertisement data reception unit which receives advertisement data from a sponsor who wants the advertisement data to be distributed on an advertisement opportunity;
an advertisement opportunity reception unit which receives an advertisement opportunity offered by media;
a distribution accepting unit which receives information representing that distribution of the advertisement data is appropriate/inappropriate from the media when the sponsor selects the advertisement opportunity received by said advertisement opportunity reception unit for distributing the advertisement data received by said advertisement data reception unit, and accepts an application for distribution of the advertisement data from the sponsor when determined that the information from the media represents that distribution in appropriate; and
a trade process unit which performs a process for trading the advertisement opportunity based on the application accepted by said distribution accepting unit.

13. The market control server according to claim 12, wherein in a case where said distribution accepting unit accepts applications for distribution of advertisement data from a plurality of sponsors for a same advertisement opportunity, said trade process unit puts up the advertisement opportunity for auction.

14. The market control server according to claim 12, further comprising:
an advertisement data registration unit which registers the advertisement data received by said advertisement data reception unit;
an advertisement opportunity registration unit which registers the advertisement opportunity received by said advertisement opportunity reception unit; and
an advertisement opportunity publicizing unit which publicizes information on the advertisement opportunity registered in said advertisement opportunity registration unit via said communication network,
wherein said distribution accepting unit accepts an application for distribution of the advertisement data registered in said advertisement data registration unit from the sponsor.

15. The market control server according to claim 14, wherein:
a plurality of advertisement data can be registered by a sponsor in said advertisement data registration unit for one advertisement opportunity; and
in a case where the media determines that the plurality of advertisement data of the sponsor are appropriate for distribution on the one advertisement opportunity, said distribution accepting unit accepts an application for distribution of one advertisement data designated by the sponsor from the plurality of advertisement data, as one to be actually distributed.

16. The market control server according to claim 15, wherein said advertisement data reception unit changes the advertisement data designated by the sponsor as one to be actually distributed with another advertisement data among the plurality of advertisement data in accordance with an instruction from the sponsor.

17. The market control server according to claim 12, wherein:
said advertisement data reception unit receives a genre of the advertisement data;
said advertisement opportunity reception unit receives a prohibited genre for designating a genre which will not be distributed on the advertisement opportunity; and
said server further comprises an advertisement data check unit which checks whether the genre of the advertisement data distribution of which on the advertisement opportunity the sponsor applies for corresponds to the prohibited genre or not, and notifies a result of checking to the media.

18. The market control server according to claim 14, wherein:
said advertisement data registration unit registers a genre of the advertisement data;
said advertisement opportunity registration unit registers a prohibited genre for designating a genre which will not be distributed on the advertisement opportunity; and
said system further comprises an advertisement data check unit which checks whether the genre of the advertisement data distribution of which on the advertisement opportunity the sponsor applies for corresponds to the prohibited genre or not, and notifies a result of checking to the media.

19. The market control server according to claim 12, further comprising a competition check unit which checks whether a plurality of sponsors compete in a same business category or not in a case where said distribution accepting unit accepts applications for distribution of advertisement data from the plurality of sponsors for one advertisement opportunity, wherein:
said competition check unit checks whether or not competition exists among the plurality of sponsors by a business category of the sponsor; and
said trade process unit permits an application for distribution of advertisement data on the advertisement opportunity from only one sponsor for each business category among the plurality of sponsors, in a case where competition among the plurality of sponsors is detected by checking of said competition check unit.

20. The market control server according to claim 14, further comprising a competition check unit which checks whether a plurality of sponsors compete in a same business category or not in a case where said distribution accepting unit accepts applications for distribution of advertisement data from the plurality of sponsors for one advertisement opportunity, wherein:
said competition check unit checks whether or not competition exists among the plurality of sponsors by a business category of the sponsor; and
said trade process unit permits an application for distribution of advertisement data on the advertisement opportunity from only one sponsor for each business category among the plurality of sponsors, in a case where competition among the plurality of sponsors is detected by checking of said competition check unit.

21. The market control server according to claim 12, further comprising an advertisement data mirroring unit which transmits advertisement data which is determined as appropriate for distribution by the media to an advertisement distribution controller which performs distribution of advertisement data, wherein:
said advertisement data mirroring unit transmits the advertisement data to said advertisement distribution controller before a trade for an advertisement opportunity is started by said trade process unit; and
said advertisement distribution controller stores the transmitted advertisement data, and performs distribution of the stored advertisement data which is to be distributed on an advertisement opportunity, in a case where a contract for the advertisement opportunity is settled.

22. The market control server according to claim 14, further comprising an advertisement data mirroring unit which transmits advertisement data which is determined as appropriate for distribution by the media to an advertisement distribution controller which performs distribution of advertisement data, wherein:
said advertisement data mirroring unit transmits the advertisement data to said advertisement distribution controller before a trade for an advertisement opportunity is started by said trade process unit; and
said advertisement distribution controller stores the transmitted advertisement data, and performs distribution of the store advertisement data, which is to be distributed on an advertisement opportunity, in a case where a contract for the advertisement opportunity is settled.

23. An advertisement opportunity trading method for communicating a terminal of a sponsor of an advertisement and a terminal of media who distributes an advertisement with each other via a communication network, in order to intermediate between the sponsor and the media for facilitating a trade for an advertisement opportunity offered by the media, said method comprising:
receiving advertisement data from a sponsor who wants the advertisement data to be distributed on an advertisement opportunity;
receiving an advertisement opportunity offered by media;
receiving information representing that distribution of the advertisement data is appropriate/inappropriate from the media when the sponsor selects the advertisement opportunity received in said receiving an advertisement opportunity for distributing the advertisement data received in said receiving advertisement data, and accepting an application for distribution of the advertisement data from the sponsor when determined that the information from the media represents that distribution is appropriate; and
performing a trading process for trading the advertisement opportunity based on the application accepted in said receiving information and accepting an application.

24. The advertisement opportunity trading method according to claim 23, wherein in a case where applications for distribution of advertisement data from a plurality of sponsors are accepted in said receiving information and accepting an application for a same advertisement opportunity, the advertisement opportunity is put up for auction in said performing a trading process.

25. The advertisement opportunity trading method according to claim 23, further comprising:
registering the advertisement data received in said receiving advertisement data;
registering the advertisement opportunity received in said receiving an advertisement opportunity; and
publicizing information on the advertisement opportunity registered in said registering the advertisement opportunity via said communication network,
wherein an application for distribution of the advertisement data registered in said registering the advertisement data is accepted from the sponsor in said receiving information and accepting an application.

26. The advertisement opportunity trading method according to claim 25, wherein:
a plurality of advertisement data can be registered by a sponsor in said registering the advertisement data for one advertisement opportunity; and
in a case where the media determines that the plurality of advertisement data of the sponsor are appropriate for distribution on the one advertisement opportunity, an application for distribution of one advertisement data designated by the sponsor from the plurality of advertisement data is accepted as one to be actually distributed in said receiving information and accepting an application.

27. The advertisement opportunity trading method according to claim 26, wherein the advertisement data designated by the sponsor as one to be actually distributed is changed with another advertisement data among the plurality of advertisement data in accordance with an instruction from the sponsor in said receiving advertisement data.

28. The advertisement opportunity trading method according to claim 23, wherein:
a genre of the advertisement data is received in said receiving advertisement data;
a prohibited genre for designating a genre which will not be distributed on the advertisement opportunity is received in said receiving an advertisement opportunity; and
said method further comprises checking whether the genre of the advertisement data distribution of which on the advertisement opportunity the sponsor applies for corresponds to the prohibited genre or not, and notifying a result of checking to the media.

29. The advertisement opportunity trading method according to claim 25, wherein:
a genre of the advertisement data is registered in said registering the advertisement data;
a prohibited genre for designating a genre which will not be distributed on the advertisement opportunity is registered in said registering the advertisement opportunity; and
said method further comprises checking whether the genre of the advertisement data distribution of which on the advertisement opportunity the sponsor applies for corresponds to the prohibited genre or not, and notifying a result of checking to the media.

30. The advertisement opportunity trading method according to claim 23, further comprising checking whether a plurality of sponsors compete in a same business category or not in a case where applications for distribution of advertisement data from the plurality of sponsor are accepted in said receiving information and accepting an application for one advertisement opportunity, wherein:
whether or not competition exists among the plurality of sponsors is checked by a business category of the sponsor in said checking; and
an application for distribution of advertisement data on the advertisement opportunity from only one sponsor for each business category among the plurality of sponsors is permitted in said performing a trading process, in a case where competition among the plurality of sponsors is detected in said checking.

31. The advertisement opportunity trading method according to claim 25, further comprising checking whether a plurality of sponsors compete in a same business category or not in a case where applications for distribution of advertisement data from the plurality of sponsors are accepted in said receiving information and accepting an application for one advertisement opportunity, wherein:
whether or not competition exists among the plurality of sponsors is checked by a business category of the sponsor in said checking; and
an application for distribution of advertisement data on the advertisement opportunity from only one sponsor for each business category among the plurality of sponsors is permitted in said performing a trading process, in a case where competition among the plurality of sponsors is detected in said checking.

32. The advertising opportunity trading method according to claim 23, further comprising transmitting advertisement data which is determined as appropriate for distribution by the media to an advertisement distribution controller which performs distribution of advertisement data for mirroring purpose, wherein:
the advertisement data is transmitted to said advertisement distribution controller in said transmitting advertisement data before a trade for an advertisement opportunity is started in said performing a trading process; and
the advertisement data is stored in said advertisement distribution controller and is to be distributed on an advertisement opportunity by said advertisement distribution controller, in a case where a contract for the advertisement opportunity is settled.

33. The advertisement opportunity trading method according to claim 25, further comprising transmitting advertisement data which is determined as appropriate for distribution by the media to an advertisement distribution controller for performing distribution of advertisement data for mirroring purpose, wherein:
the advertisement data is transmitted to said advertisement distribution controller in said transmitting advertisement data before a trade for an advertisement opportunity is started in said performing a trading process; and
the advertisement data is stored in said advertisement distribution controller and is to be distributed on an advertisement opportunity by said advertisement distribution controller, in a case where a contract for the advertisement opportunity is settled.

34. A computer-readable recording medium which stores a program for controlling a computer to function as:
advertisement data receiving means for receiving advertisement data from a sponsor who wants the advertisement data to be distributed on an advertisement opportunity;
advertisement data registering means for registering the advertisement data received by said advertisement data receiving means;
advertisement opportunity receiving means for receiving an advertisement opportunity offered by media;
advertisement opportunity registering means for registering the advertisement opportunity received by said advertisement opportunity receiving means;
advertisement opportunity publicizing means for publicizing information on the advertisement opportunity registered by said advertisement opportunity registering means via said communication network;
distribution accepting means for receiving information representing that distribution of the advertisement data is appropriate/inappropriate from the media when the sponsor selects the advertisement opportunity publicized by said advertisement opportunity publicizing means for distributing the advertisement data registered by said advertisement data registering means, and accepting an application for distribution of the advertisement data registered by said advertisement data registering means from the sponsor when determined that the information from the media represents that distribution is appropriate; and
a trade processing means for performing a process for trading the advertisement opportunity based on the application accepted by said distribution accepting means.

35. The computer-readable recording medium according to claim 34, storing a program for controlling a computer to further function as advertisement data checking means for checking whether or not a genre of the advertisement data distribution of which on the advertisement opportunity the sponsor applies for corresponds to a prohibited genre which designates a genre which will not be distributed on the advertisement opportunity, and notifying a result of checking to the media.

36. The computer-readable recording medium according to claim 34, storing a program for controlling a computer to further function as competition checking means for checking whether a plurality of sponsors compete in a same business category or not in a case where applications for distribution of advertisement data from the plurality of sponsors are accepted by said distribution accepting means for one advertisement opportunity, and permitting an application for distribution of advertisement data on the advertisement opportunity from only one sponsor for each business category among the plurality of sponsors in a case where competition exists among the plurality of sponsors.

37. The computer-readable recording medium according to claim 34, storing a program for controlling a computer to further function as:
advertisement data mirroring means for transmitting advertisement data which is determined as appropriate for distribution by the media to advertisement distribution controlling means for performing distribution of advertisement data before a trade for an advertisement opportunity is started by said trade processing means; and
advertisement distribution controlling means for storing the transmitted advertisement data and performing distribution of the stored advertisement data which is to be distributed on an advertisement opportunity, in a case where a contract for the advertisement opportunity is settled.

38. An advertisement distribution control apparatus which provides information and an advertisement to a terminal of an audience, said apparatus comprising:
distributing means for distributing an advertisement to said terminal of an audience from a market control server which intermediates between a sponsor of an advertisement and various kinds of media which distribute advertisements to facilitate a trade for an advertisement opportunity; and
storing means for receiving advertisement data to be provided to an audience from said market control server, and storing the received advertisement data,
wherein said distributing means starts distributing the advertisement data stored in said storing means to said terminal of an audience from a time set for the advertisement opportunity.

39. An advertisement distribution control method for providing information and an advertisement to a terminal of an audience, said method comprising:
distributing an advertisement to said terminal of an audience from a market control server which intermediates between a sponsor of an advertisement and various kinds of media which distribute advertisements to facilitate a trade for an advertisement opportunity; and
receiving advertisement data to be provided to an audience from said market control server, and storing the received advertisement data,
wherein distribution of the advertisement data stored in said receiving and storing advertisement data to said terminal of an audience is started in said distributing from a time set for the advertisement opportunity.

40. A computer-readable recording medium which stores a program for controlling a computer to function as:
distributing means for distributing an advertisement to said terminal of an audience from a market control server which intermediates between a sponsor of an advertisement and various kinds of media which distribute advertisements to facilitate a trade for an advertisement opportunity;
storing means for receiving advertisement data which is made of data regarding an advertisement to be provided to an audience from said market control server, and storing the received advertisement data; and
distribution starting means for starting distribution of the advertisement data stored in said storing means to said terminal of an audience from a time set for the advertisement opportunity.
